(19) United States
(12) Patent Application Publication
(10) Pub. No.: US 2021/0200136 A1
(43) Pub. Date: Jul. 1, 2021

(54) CLEANING BLADE, PROCESS CARTRIDGE, AND IMAGE FORMING APPARATUS

(71) Applicants: Keiichiro JURI, Kanagawa (JP); Yuka AOYAMA, Kumamoto (JP)

(72) Inventors: Keiichiro JURI, Kanagawa (JP); Yuka AOYAMA, Kumamoto (JP)

(21) Appl. No.: 17/058,357

(22) PCT Filed: Jul. 3, 2019
(86) PCT No.: PCT/JP2019/026413

§ 371 Date: Nov. 24, 2020

(30) Foreign Application Priority Data
Jul. 26, 2018 (JP) 2018-140509
May 7, 2019 (JP) 2019-087641

(51) Int. Cl. G03G 21/00

(52) U.S. Cl. CPC G03G 21/0017; G03G 21/0029

(57) ABSTRACT

A cleaning blade includes an elastic member to contact a surface of a cleaning target member. The elastic member includes a base material and a surface layer on at least a part of a lower surface of the base material including a contact part. Martens hardness of the surface layer has a gradient of decrease from a surface of the surface layer toward the lower surface of the base material in a film thickness direction. The Martens hardness is 2.5 to 32.5 N/mm² in a range from a vicinity of the surface (with a load of 1 μN) to a deepest part in the film thickness direction (with a load of 1000 μN). An average film thickness of the surface layer is 10 μm or more to 500 μm or less. A content of a siloxane-based compound in the surface layer is 4 to 15% by mass.

### TECHNICAL FIELD

The present invention relates to a cleaning blade, a process cartridge, and an image forming apparatus.

### BACKGROUND ART

Conventionally, in electrophotographic image forming apparatuses, for image bearers (hereinafter, also referred to as “photoconductors”, “electrophotographic photoconductors”, or “electrostatic latent image bearers”) as cleaning target members, it is known that unnecessary adhering substances such as residual transfer toners adhering to surfaces after the transfer of toner images to transfer sheets or intermediate transfer bodies are removed by cleaning means.

As cleaning members for the cleaning means, cleaning members that use a strip-shaped cleaning blade are well known, because the configurations of the members can be generally simplified, also with excellent cleaning performance. With the base end of the cleaning blade supported by a supporting member, the contact part (tip ridge) is pressed against the peripheral surface of the image bearer, and the toner remaining on the image bearer is blocked and scraped off for removal.

Further, in order to meet the recent demand for higher image quality, image forming apparatuses are known which use a toner small in particle size and close to a spherical shape formed by a polymerization method or the like (hereinafter, referred to as a “polymerization toner”). The polymerization toner is characterized in that the transfer efficiency is higher as compared with the transfer efficiency of a conventional ground toner and the like, and capable of meeting the demand. Even if, however, an attempt is made to remove the polymerization toner from the surface of the image bearer with the use of the cleaning blade, it is difficult to remove the polymerization toner sufficiently, and there is a disadvantage that defective cleaning is caused. This is because the polymerization toner small in particle diameter and excellent in circularity slips through a slight gap formed between the cleaning blade and the image bearer.

In order to suppress the slippage, there is a need to increase the contact pressure between the image bearer and the cleaning blade to enhance the cleaning ability. However, when the contact pressure is increased, turn-up is caused as illustrated in FIG. 9A. In addition, when the turned-up cleaning blade is used, local wear is caused as illustrated in FIG. 9B, and eventually, the tip ridge is missing as illustrated in FIG. 9C.

In order to solve such a problem, for example, PTL 1 proposes that a contact part of an elastic member made of a polyurethane elastomer is provided with a surface layer made of a resin that has a film hardness of pencil hardness B to 6H. In addition, PTL 2 proposes a cleaning blade obtained by impregnating an elastic member made of a rubber with an ultraviolet curable composition containing a silicone to swell the elastic member, and then applying an ultraviolet irradiation treatment to the ultraviolet curable composition to cure the ultraviolet curable composition. In addition, PTL 3 proposes a cleaning blade that has a part including a contact part of an elastic member, impregnated with at least one selected from an isocyanate compound, a fluorine compound, and a silicone compound, and has a harder surface layer than the elastic member, provided on the surface of the elastic member including the contact part. In addition, Patent Document 4 proposes a cleaning blade including a surface layer containing lubricating particles and a binder resin.

### CITATION LIST

### Patent Literature

PTL 1: JP-3602898-B

PTL 2: JP-2004-233818-A

PTL 3: JP-5532378-B

PTL 4: JP-2962843-B

### SUMMARY OF INVENTION

### Technical Problem

The conventional cleaning blade provided with the surface layer and cleaning blade provided with the impregnated part may, however, cause defective cleaning under such severe conditions for cleaning in the formation of continuous solid images or the like with very large amounts of powder formed on the image bearer.

Further, in recent years, there is an increasing need for speed-up in electrophotographic image forming apparatuses. When the image forming speed is increased, the image bearer rotating at high speed is finely vibrated due to the axial deviation of the image bearer, and the conventional cleaning blades have failed to sufficiently cope with the higher-speed image forming apparatus. In addition, the cleaning blades have failed to sufficiently cope with the followability to micro waviness at the surface of the image bearer. Furthermore, there is also increasing demand for long life. The conventional cleaning blades have been more likely to cause defects such as abnormal noise generation, with the increased torque with the image bearer due to wear of the contact part.

In addition, even with the cleaning blade with the surface layer formed on the part including the contact part, it is difficult to increase the film thickness of the surface layer on the contact part in a case where the surface layer is formed by a method such as spray coating, and the surface layer wears out early. Thus, when the base material of the elastic member comes into contact with the image bearer, the defect of the increased torque with the image bearer is caused. When the torque is increased, a load is applied on the rotation of the image bearer, and for example, a color shift is caused in a tandem system.

Further, for example, as in PTL 4, in the case of the blade provided with the surface layer including the lubricating particles, the edge accuracy of the contact part is degraded by the presence of the lubricating particles on the surface, and it is difficult to maintain the cleaning performance with recent higher-speed image forming apparatuses or spherical toners.

The present invention has been achieved in view of the foregoing background, and an object of the present invention to provide a cleaning blade capable of suppressing the generation of abnormal noise due to turn-up of a tip ridge, abnormal wear, or the like, maintaining favorable cleaning ability over a long period of time, and preventing color shifts in a tandem system.

### Solution to Problem

A cleaning blade includes an elastic member to contact a surface of a cleaning target member and remove an adhering substance adhering to the surface of the cleaning target member. The elastic member includes a base material and a surface layer including a cured product of a curable composition. The surface layer is disposed on at least a part of a lower surface of the base material including a contact part to contact the cleaning target member. The lower surface of the base material is a surface of the base material facing a downstream side in a travelling direction of the cleaning target member with respect to the contact part. The surface layer contains a siloxane-based compound. Martens hardness of the surface layer measured with a nano indenter has a hardness gradient of decrease from a surface of the surface layer toward the lower surface of the base material in a film thickness direction of the surface layer. The Martens hardness is 2.5 to 32.5 N/mm² in a range from a vicinity of the surface (with a load of 1 μN) to a deepest part in the film thickness direction (with a load of 1000 μN). An average film thickness of the surface layer is 10 μm or more to 500 μm or less.

A content of the siloxane-based compound in the surface layer is 4 to 15% by mass.

### Advantageous Effects of Invention

The present invention can provide a cleaning blade capable of suppressing the generation of abnormal noise due to turn-up of a tip ridge, abnormal wear, or the like, maintaining favorable cleaning ability over a long period of time, and preventing color shifts in a tandem system.

### BRIEF DESCRIPTION OF DRAWINGS

FIG. 1 is an enlarged cross-sectional view illustrating an example of a cleaning blade according to an embodiment of the present invention in contact with the surface of an image bearer.

FIG. 2 is a perspective view showing an example of a cleaning blade according to an embodiment of the present invention.

FIG. 3A is an illustration of an example of a method for producing a cleaning blade according to an embodiment of the present invention.

FIG. 3B is an illustration of another example of the method for producing the cleaning blade according to an embodiment of the present invention.

FIG. 4 is an explanatory diagram of an elastic work rate.

FIG. 5 is a schematic configuration diagram illustrating an example of an image forming apparatus according to an embodiment of the present invention.

FIG. 6 is a schematic configuration diagram illustrating an example of an image formation unit included in the image forming apparatus according to an embodiment of the present invention.

FIG. 7A is an explanatory diagram for explaining a method for measuring the circularity of a toner.

FIG. 7B is an explanatory diagram for explaining the method for measuring the circularity of a toner.

FIG. 8 is a diagram for explaining an example of a method for measuring the average thickness of a surface layer.

FIG. 9A is a view illustrating a turned-up tip ridge of a conventional cleaning blade.

FIG. 9B is a view for explaining local wear of a tip surface of the cleaning blade.

FIG. 9C is a view illustrating a missing part of the tip ridge of the cleaning blade.

FIG. 10 is a view for explaining a cutout site of a base material in measuring the Martens hardness (HM) of the base material.

FIGS. 11A to 11C are views for explaining a measurement position of the Martens hardness (HM) of a base material.

### DESCRIPTION OF EMBODIMENTS

Hereinafter, a cleaning blade, a process cartridge, and an image forming apparatus according to embodiments of the present invention will be described with reference to the drawings. It is to be noted that the present invention is not to be considered limited to the following embodiments, but can be changed within the range that can be conceived of by those skilled in the art, such as other embodiments, additions, modifications, deletions, and the scope of the present invention encompasses any aspect, as long as the aspect achieves the operation and advantageous effect of embodiments of the present invention.

(Cleaning Blade)

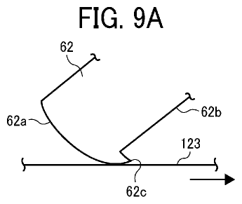

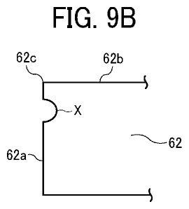

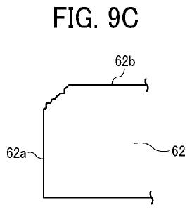

Conventionally, in the case of using a polymerization toner which is small in particle size and excellent in sphericity, there is a disadvantage that the polymerization toner slips through a slight gap formed between a cleaning blade and an image bearer. In order to suppress the slippage, there is a need to increase the contact pressure between the image bearer and the cleaning blade to enhance the cleaning ability. However, when the contact pressure of the cleaning blade is increased, as illustrated in FIG. 9A, the frictional force between an image bearer 123 and a cleaning blade 62 is increased, and the cleaning blade 62 is then pulled in the moving direction of the image bearer 123. Thus, the cleaning blade 62 has a tip ridge 62c turned up. When the turned-up cleaning blade 62 restores to its original condition against the turn-up, an abnormal noise may be generated.

Furthermore, if cleaning is continued with the tip ridge 62c of the cleaning blade 62 turned up, local wear X will be caused at a site several micrometers away from the tip ridge 62c of a blade tip surface 62a of the cleaning blade 62 as illustrated in FIG. 9B. Under such conditions, if the cleaning is further continued, this local wear will be increased. Eventually, as illustrated in FIG. 9C, the tip ridge 62c is missing. As described above, if the tip ridge 62c is missing, there is a disadvantage that the ability to normally clean the toner is lost, which leads to defective cleaning. It is to be noted that in FIGS. 9A to 9C, reference numeral 62b denotes the lower surface of the cleaning blade.

On the other hand, the cleaning blade according to an embodiment of the present invention (hereinafter, simply referred to as a blade) includes an elastic member that comes into contact with a surface of a cleaning target member and removes an adhering substance adhering to the surface of the cleaning target member, the elastic member includes a base material and a surface layer including a cured product of a curable composition, the surface layer is formed on at least a part of a lower surface of the base material including a contact part, when the surface of the base material facing the downstream side in the travelling direction of the cleaning target member with respect to the contact part in contact with the cleaning target member is regarded as the lower surface of the base material, the surface layer contains a siloxane-based compound, and the surface layer has a hardness gradient of decrease from the surface toward the lower surface of the base material in the film thickness direction. Specifically, the hardness gradient can be obtained by measuring the Martens hardness HM in the vicinity of the surface of the surface layer (with a load of 1 μN), the deepest part of the layer in the film thickness direction (with a load of 1000 μN), and a middle site (with a load of 50 μN) of the layer according to the present invention.

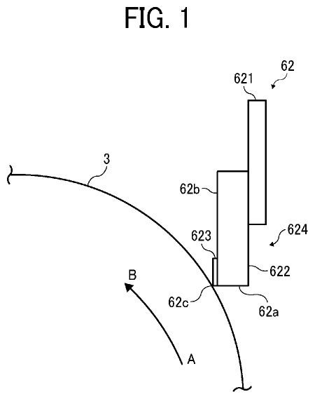

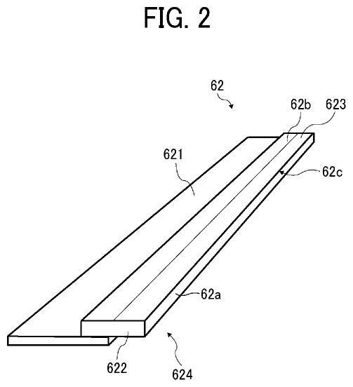

A cleaning blade according to an embodiment of the present invention will be described with reference to FIGS. 1 and 2. FIG. 1 is an explanatory diagram of a cleaning blade 62 in contact with the surface of a photoconductor 3, and FIG. 2 is a perspective view of the cleaning blade 62. In the cleaning blade 62 in the drawing, a supporting member 621, an elastic member 624, a base material 622, and a surface layer 623 are illustrated, and the base material 622 according to the present embodiment has a strip shape. In addition, the blade tip surface 62a, the blade lower surface 62b, and the tip ridge 62c (also referred to as a contact part, an edge part, or the like) are illustrated.

According to the present disclosure, the longitudinal surface of the base material including the elastic member, facing the downstream side in the traveling direction (the rotating direction in this embodiment) of a cleaning target member is referred to as the lower surface of the base material, and the surface at the tip facing the upstream side in the rotating direction of the cleaning target member, including the tip ridge of the base material, is referred to as the tip surface of the base material. In addition, the longitudinal surface of the elastic member, facing the downstream side in the rotating direction of the cleaning target member is referred to as the blade lower surface, and the surface at the tip facing the upstream side in the rotating direction of the cleaning target member, including the tip ridge of the elastic member material, is referred to as the blade tip surface.

In FIG. 1, the surface 62b facing the downstream side B in the traveling direction of a cleaning target member serves as the blade lower surface, and the surface 62a at the tip facing the upstream side A in the traveling direction of the cleaning target member serves as the blade tip surface.

In addition, the contact part of the elastic member in contact with the surface of the to-be cleaned-member includes the tip ridge of the elastic member. In addition, in a case where the tip ridge is turned up, or in a case where the increased linear pressure is applied, a part of the blade tip surface may also serve as a contact part.

According to the present embodiment, the surface layer of the contact part of the cleaning blade is preferably 10 μm to 500 μm in an average film thickness, and the surface layer which has hardness gradient and contains a siloxane-based compound can prevent the tip ridge from being turned up, and suppress excessive stick-slip. Furthermore, even if the cleaning blade is worn by long-term use, the thick surface layer can prevent the base material of the elastic member from being exposed and suppress a torque increase and a squeal, and makes it possible to maintain these functions. Thus, a balance can be achieved between turn-up reduction and the blade wear resistance, and favorable cleaning performance can be maintained over a long period of time. In addition, the base of the elastic member can be prevented from coming into contact with the image bearer, and the torque and the load on the rotation of the image bearer can be thus kept from being increased. Thus, for example, a color shift in a tandem system can be prevented. It is to be noted that the cleaning blade according to the present invention is not to be considered limited to the tandem system.

When the surface layer of the contact part is 500 μm or less in an average film thickness, the flexibility of the elastic member of the base material is maintained to improve the followability to the vibration due to the axial deviation of the image bearer and the micro waviness of the image bearer surface, and thus cleaning failures is prevented. In addition, when the average film thickness is 10 μm or more, abnormal noise due to abnormal wear and the like is prevented.

The surface layer of the contact part of the cleaning blade is more preferably 50 μm or more and 200 μm or less in an average film thickness. The thickness of 50 μm or more and 200 μm or less makes the contact part less likely to be initially turned up, and can keep wear in the surface layer even if the wear progresses to suppress the exposure of the base material of the elastic member. Thus, even in long-term use, the turn-up, squeal, and defective cleaning are less likely to be caused.

In this regard, the average film thickness of the surface layer of the contact part can be determined by the arithmetic average value obtained by measuring 10 random points of the surface layer in the contact part. There is no particular limit on the method for measuring the thickness, which can be selected appropriately for any purpose, and examples of the method include a method of measuring a cut surface including the surface layer of the contact part with the use of a microscope. Specifically, for example, the thickness of the surface layer is measured at a position of 50 μm to 200 μm from the tip (contact side) of the contact part. In addition, typically, the thickness is measured at a position excluding both ends of 2 cm in the longitudinal direction (the direction of the contact side).

<Method for Producing Cleaning Blade>

Conventionally, it is difficult for previous blades manufactured by spraying or dip coating to have a thick film for the surface layer of the contact part, and the contact part is less than 1 to 3 μm even though there is a film of 10 μm near the contact part. Moreover, with such a film deposited, the contact part is rounded, and the edge accuracy is thus reduced. For this reason, there is a possibility that the cleaning performance has been degraded.

Further, the related art, for example, JP-5515865-B discloses a method for producing a cleaning blade, which includes the steps of impregnating a sheet material made of a long polyurethane rubber with an impregnating agent, and then cutting the material, and further applying and curing a coating agent containing a resin to form a coat film. In this case, since the coat film is applied later, the film thickness of the edge is reduced, and there is thus a possibility that the torque may be increased with time. Moreover, Patent Literature 4 describes a cleaning blade including a film layer containing lubricating particles, with edges cut after the formation of the film layer. However, since the lubricating particles are dispersed, the surface roughness of the film layer is increased, and even if the edges are cut after the formation of the film layer, there is a possibility of reducing the edge accuracy and degrading the cleaning performance.

On the other hand, for the cleaning blade 62 according to the present embodiment, a curable composition for forming the surface layer 623 is applied to the base material 622 made of, for example, a urethane rubber, and then, the resin is cured by thermal curing. Thereafter, the contact part is cut to be processed into a blade shape. In addition, the surface layer 623 contains a siloxane-based compound, and has a hardness gradient of decrease from the surface toward the lower surface of the base material in the film thickness direction.

The surface layer 623 is formed by coating at least the tip ridge 62c of the cleaning blade 62 by spray coating, dip coating, die coating, or the like with the use of the curable composition.

The surface layer on the lower surface of the base material can be formed by bar coating, spray coating, dip coating, brush coating, screen printing, or the like. It is possible to control the film thickness of the surface layer by appropriately changing the conditions such as the solid content concentration of the coating liquid, the coating conditions (bar coating: gap, spray coating: discharge amount, distance, moving speed, dip coating: pulling speed, etc.), and the frequency of coating.

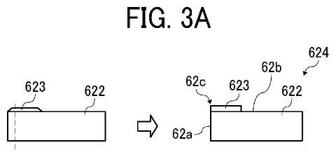

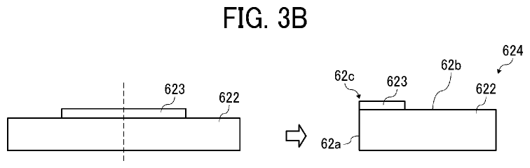

FIGS. 3A and 3B illustrate a part of a method for producing the cleaning blade according to the present embodiment. FIGS. 3A and 3B are views of the elastic member of the cleaning blade as viewed from the side surface. The view on the left side of FIG. 3A illustrates the curable composition applied and cured on the base material 622. The tip surface of the base material 622 is cut as illustrated by the dashed line to prepare the elastic member 624 illustrated on the right side of FIG. 3A. Although the site to be cut can be changed appropriately, for example, the site of 1 mm from the tip is cut.

Further, FIG. 3B illustrates another example. The view on the left side of FIG. 3B illustrates, as in FIG. 3A, the curable composition applied and cured on the base material 622. The tip surface of the base material 622 is not cut as in FIG. 3A, but is cut near the center of the base material 622. In this case, it is also possible to prepare two cleaning blades simultaneously.

Further, besides the foregoing method, a method may be used in which a curable composition is cured with the use of a mold to form a right-angle contact part.

It is possible to appropriately change the method for cutting the base material 622 and the surface layer 623, and for example, a vertical slicer or the like can be used.

In addition, although the cutting direction can be changed appropriately, it is suitable to carry out cutting from the surface layer 623 toward the base material 622. In this case, the edge accuracy can be improved.

According to the present embodiment, forming the thick film of the surface layer 623 on the lower surface of the base material and then cutting the edge, thereby making it possible to achieve a balance between the thick film of the contact part and the edge accuracy.

<Cleaning Target Member>

There is no particular limit on the material, shape, structure, size, and the like of the cleaning target member, which can be selected appropriately for any purpose. Examples of the shape of the cleaning target member include shapes such as a drum, a belt, a plate, and a sheet. There is no particular limit on the size of the cleaning target member, which can be selected appropriately for any purpose, but is preferably a size appropriate for typical use.

There is no particular limit on the material of the cleaning target member, which can be selected appropriately for any purpose, and examples of the material include metals, plastics, and ceramics.

In addition, there is no particular limit on the cleaning target member, which can be selected appropriately for any purpose, and examples of the member include an image bearer, in a case where the cleaning blade is applied to an image forming apparatus.

<Adhering Substance>

The adhering substance is not limited to any particular substance as long as the substance adheres to the surface of the cleaning target member as a target of removal by the cleaning blade, and the substance can be selected appropriately for any purpose. Examples of the adhering substance include toners, lubricants, inorganic microparticles, organic microparticles, waste, dust, or a mixture thereof. Above all, toners are suitable, and a low-temperature fixing toner that has a glass transition temperature of 50° C. or lower is particularly suitable.

<Supporting Member>

The cleaning blade according to the present embodiment preferably includes a supporting member and a plate-shaped elastic member that has one end coupled to the supporting member and a free end with a predetermined length at the other end. The cleaning blade is disposed such that the contact part including the tip ridge, which is one end of the elastic member on the free end side, comes into contact with the surface of the cleaning target member in the longitudinal direction.

There is no particular limit on the shape, size, material, and the like of the supporting member, which can be selected appropriately for any purpose. Examples of the shape of the supporting member include shapes such as a plate, a strip, and a sheet. There is no particular limit on the size of the supporting member, which can be selected appropriately depending on the size of the cleaning target member.

Examples of the material of the supporting member include metals, plastics, and ceramics. Among these materials, metal plates are suitable in terms of strength, and steel plates such as stainless steel, aluminum plates, and phosphor bronze plates are particularly suitable.

<Base Material>

There is no particular limit on the shape, material, size, structure, and the like of the base material 622 of the elastic member 624, which can be selected appropriately for any purpose.

Examples of the shape include shapes such as a plate, a strip, and a sheet.

There is no particular limit on the size, which can be selected appropriately depending on the size of the cleaning target member.

There is no particular limit on the material, which can be selected appropriately for any purpose, but polyurethane rubbers, a polyurethane elastomers, and the like are suitable from the viewpoint of easily obtaining high elasticity.

There is no particular limit on the method for producing the base material of the elastic member, which can be selected appropriately for any purpose. The base material is produced by, for example, preparing a polyurethane prepolymer with the use of a polyol compound and a polyisocyanate compound, adding a curing agent and, if necessary, a curing catalyst to the polyurethane prepolymer for cross-linking in a predetermined mold, molding a product obtained by post-crosslinking in a furnace, into a sheet by centrifugal molding, and then cutting the sheet left to stand at room temperature and aged, into a plate with a predetermined size.

There is no particular limit on the polyol compound, which can be selected appropriately for any purpose, and examples of the compound include high-molecular-weight polyols and low-molecular-weight polyols.

Examples of the high-molecular-weight polyols include polyester polyols which are condensation products of alkylene glycols and aliphatic dibasic acids; polyester-based polyols such as polyester polyols of alkylene glycols and adipic acids, such as ethylene adipate ester polyols, butylene adipate ester polyols, hexylene adipate ester polyols, ethylene propylene adipate ester polyols, ethylene butylene adipate ester polyols, and ethylene neopentylene adipate ester polyols; polycaprolactone-based polyols such as polycaprolactone ester polyols obtained by ring-opening polymerization of caprolactone; and polyether-based polyols such as poly(oxytetramethylene) glycols and poly(oxypropylene) glycols. These examples may be used alone, or two or more example may be used in combination.

Examples of the low-molecular-weight polyols include dihydric alcohols such as 1,4-butanediol, ethylene glycol, neopentyl glycol, hydroquinone-bis(2-hydroxyethyl) ether, 3,3′-dichloro-4,4′-diaminodiphenylmethane, and 4,4′-diaminodiphenylmethane; and trihydric or higher polyhydric alcohols such as 1,1,1-trimethylolpropane, glycerin, 1,2,6-hexanetriol, 1,2,4-butanetriol, trimethylolethane, 1,1,1-tris(hydroxyethoxymethyl) propane, diglycerin, and pentaerythritol. These examples may be used alone, or two or more example may be used in combination.

There is no particular limit on the polyisocyanate compound, which can be selected appropriately for any purpose, and examples of the polyisocyanate compound include methylene diphenyl diisocyanate (MDI), tolylene diisocyanate (TDI), xylylene diisocyanate (XDI), naphthalene 1,5-diisocyanate (NDI), tetramethylxylene diisocyanate (TMXDI), isophorone diisocyanate (IPDI), hydrogenated xylylene diisocyanate (H6XDI), dicyclohexylmethane diisocyanate (H12MDI), hexamethylene diisocyanate (HDI), dimer acid diisocyanate (DDI), norbornene diisocyanate (NBDI), and trimethylhexamethylene diisocyanate (TMDI). These examples may be used alone, or two or more example may be used in combination.

There is no particular limit on the curing catalyst, which can be selected appropriately for any purpose, and examples of the catalyst include amine-based compounds such as tertiary amines and organometallic compounds such as organic tin compounds. Examples of tertiary amines include trialkylamines such as triethylamine, tetraalkyl-diamines such as N,N,N′,N′-tetramethyl-1,3-butanediamine, amino alcohols such as dimethylethanolamine, ester amines such as ethoxylated amines, ethoxylated diamines, and bis(diethylethanolamine) adipate, cyclohexylamine derivatives such as tri-ethylenediamine (TEDA), N,N-dimethylcyclohexylamine, morpholine derivatives such as N-methylmorpholine, N-(2-hydroxypropyl)-dimethylmorpholine; and piperazine derivatives such as N,N′-diethyl-2-methylpiperazine and N,N′-bis-(2-hydroxypropyl)-2-methylpiperazine. Further, the organic tin compounds include dialkyltin compounds such as dibutyltin dilaurate and dibutyltin di(2-ethylhexanoate), tin(II) 2-ethylcaproate, and tin(II) oleate. These examples may be used alone, or two or more of the example may be used in combination.

The content of the curing catalyst is not particularly limited, and can be selected appropriately for any purpose, but is preferably 0.01% by mass or more and 0.5% by mass or less, more preferably 0.05% by mass or more and 0.3% by mass or less.

The JIS-A hardness of the base material is not particularly limited, and can be selected appropriately for any purpose, but is preferably 60 degrees or more, and more preferably 65 degrees or more 80 degrees or less. When the JIS-A hardness is 60 degrees or more, the blade linear pressure is easily obtained, and the area of the contact part with the image bearer is less likely to be expanded, and defective cleaning is thus less likely to be caused. In this regard, the JIS-A hardness of the base material can be measured with the use of, for example, a micro rubber hardness meter MD-1 manufactured by Kobunshi Keiki Co., Ltd.

There is no particular limit on the impact resilience modulus of the base material in conformity with JIS K6255 standards, which can be selected appropriately for any purpose. In this regard, the impact resilience modulus of the base material can be measured, for example, at 23° C. with the use of a No. 221 resilience tester manufactured by Toyo Seiki Seisaku-sho, Ltd. in conformity with JIS K6255 standards.

The average thickness of the base material is not particularly limited, and can be selected appropriately for any purpose, but is preferably 1.0 mm or more and 3.0 mm or less.

There is no particular limit on the Martens hardness of the base material, which can be selected appropriately for any purpose. A more suitable range of the Martens hardness of the base material is 0.8 N/mm² or more and 3.0 N/mm² or less. When Martens hardness of the base material is within the range of 0.8 N/mm² or more and 3.0 N/mm² or less, it is possible to reduce cracking on the surface layer of 10 μm or more, and thus make defective cleaning unlikely to be caused even in long-term use. In addition, when the Martens hardness of the base material is 0.8 N/mm² or more, the base material is not excessively soft, and deformation by the vibration or the like due to the axial deviation of the cleaning target member (for example, an image bearer) is suppressed to make it easy for the surface layer to follow the deformation of the base material. Thus, the generation of cracks is prevented, and the cleaning performance is improved.

The method for measuring the Martens hardness (HM) of the base material is as follows. The Martens hardness (HM) was measured by pushing a Berkovich indenter with a load of 1000 μN for 10 seconds, holding the indenter for 5 seconds, and pulling the indenter for 10 seconds at the same load rate, with the use of a nano indenter ENT-3100 manufactured by ELIONIX INC., based on ISO 14577. The measurement site was set at 100 μm from the tip ridge of the tip surface of the blade.

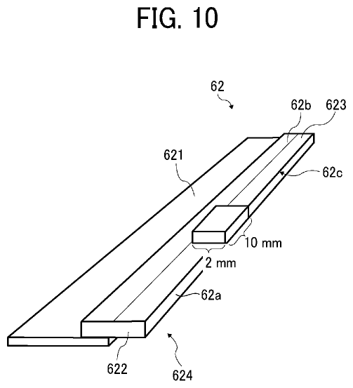

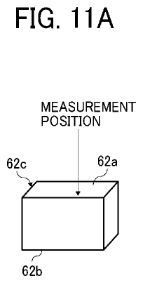

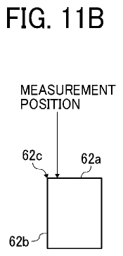

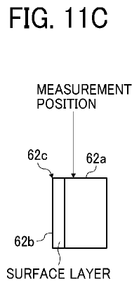

As a method for the measurement, as illustrated in FIG. 10, the base material 622 is cut out in a rectangle of 2 mm in the depth direction of the base material 622 from the blade tip surface 62a of the base material 622 (the direction orthogonal to the longitudinal direction of the base material 622) and of 10 mm in the longitudinal direction. As illustrated in the perspective view of the base material in FIG. 11A and the front view of the base material in FIG. 11B, the Martens hardness (HM) can be measured with the cut base material secured on a glass slide with an adhesive or double-sided tape so as to make the blade tip surface 62a facing upward, and with a position of 100 μm from the tip ridge 62c in the depth direction as a measurement location. On the other hand, even with the surface layer formed on the lower surface of the base material as illustrated in FIG. 11C, the Martens hardness (HM) can be measured similarly. Alternatively, the surface layer can be also cut with a razor or the like to expose the tip surface of the base material, and then measure the Martens hardness (HM). It is to be noted that the Martens hardness (HM) of the surface layer 623 described below is measured by the above-mentioned method, in a state where the base material is cut out with the surface layer formed on the lower surface of the base material as illustrated in FIG. 11C, and the cut base material is secured on a glass slide with an adhesive or double-sided tape so as to make the surface layer 623 facing upward.

<Surface Layer>

For the cleaning blade according to the present embodiment, the tip ridge 62c in contact with the image bearer is formed by the surface layer 623, and this surface layer 623 is formed from the curable composition described below (not a mixed layer with the elastic member). The surface layer 623 may be formed on the contact part and the lower surface of the base material, and the surface layer may be also formed on the blade tip surface 62a. In addition, the curable composition may be contained in the elastic member.

The surface layer 623 may cover the entire surface of the base material, but is preferably formed in a region of at least 1 mm or more, preferably 1 mm or more and 7 mm or less in the planar direction of the lower surface of the base material from the contact part. The region of 7 mm or less improves, without impairing the flexibility of the elastic member, the followability to the photoconductor and the cleaning performance.

The surface layer 623 is not particularly limited, and can be selected appropriately for any purpose, but the cured product is preferably higher in Martens hardness than the base material. The surface layer 623, adapted to serve as a member that is higher in hardness than the base material of the elastic member 622, is rigid, and thus unlikely to be deformed, and capable of preventing turn-up of the tip ridge 62c of the cleaning blade 62.

There is no particular limit on the method for curing the curable composition of the surface layer formed on the contact part of the cleaning blade, which can be selected appropriately for any purpose, and examples of the method include a treatment by heating or the like.

The elastic work rate of the cleaning blade is preferably 60% or more to 90% or less. The elastic work rate refers to a characteristic value obtained in the following way from integral stress in the measurement of the Martens hardness. The Martens hardness is measured with the use of a microhardness tester while performing the operation of pushing a Berkovich indenter with a constant force, for example, for 30 seconds, holding the indenter for 5 seconds, and pulling the indenter with a constant force for 30 seconds.

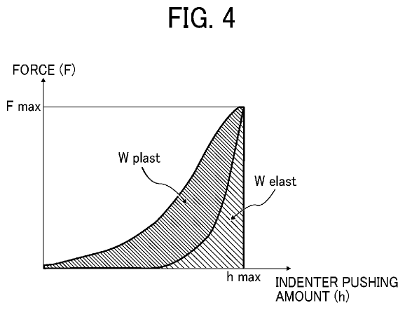

In this regard, with the integral stress Wplast in the case of pushing the Berkovich indenter and the integral stress Welast in the case of test unloading, the elastic work rate refers to the characteristic value defined by the formula of Welast/Wplast×100 [%] (See FIG. 4). As the elastic work rate is increased, the plastic deformation is reduced, that is, the rubber performance is increased. The elastic work rate of 60% or more improves the wear resistance, without reducing the movement of the contact part.

<Curable Composition>

The curable composition refers to a material that is polymerized and cured to form a cured product (solid polymer) when monomers and oligomers receive energy such as light and heat. The energy source differs depending on the type of an initiator or a stimulus (electron beam) that generates active species (radicals, ions, acids, bases, etc.) that initiate the polymerization, and examples of the source include ultraviolet curable compositions, thermosetting compositions, and electron beam curable compositions.

For the ultraviolet curable compositions and the electron beam curable compositions, with the use of a photopolymerization initiator, irradiating the compositions with ultraviolet rays or electron beams develops a curing reaction classified into any of radical polymerization, cationic polymerization, and anionic polymerization to produce a cured product through a polymerization reaction such as vinyl polymerization, vinyl copolymerization, ring-opening polymerization, or addition polymerization.

For the thermosetting compositions, with the use of a thermal polymerization initiator, a curing reaction is initiated by heating to produce a cured product through a polymerization reaction such as isocyanate, radical polymerization, epoxy ring-opening polymerization, or melamine condensation.

There is no particular limit on the cured product produced through such a reaction, which can be selected appropriately for any purpose, and examples of the produce include acrylic resins, phenol resins, urethane resins, epoxy resins, silicone resins, amino resins, or resin compositions having a polyethylene framework. However, polyurethane-based compounds such as urethane resins are suitable from the viewpoints of: excellent wear resistance; excellent conformity and adhesion of the base material to the urethane rubber; and furthermore, ease of adjusting physical properties such as hardness and elastic work rate by control of NCO groups and OH groups.

The urethane resins are not particularly limited, and can be selected appropriately for any purpose, but is preferably a combination of a prepolymer with NCO groups at both terminals with a curing agent (a compound including an NH₂ group or an OH group). The prepolymer with NCO groups at both terminals is, more preferably, a prepolymer with a polyfunctional isocyanate bonded to both terminals of a PTMG (polytetramethylene ether glycol).

There is no particular limit on the polyfunctional isocyanate of the prepolymer, which can be selected appropriately for any purpose, and examples of the polyfunctional isocyanate of the prepolymer include methylene diphenyl diisocyanate (MDI), tolylene diisocyanate (TDI), xylylene diisocyanate (XDI), naphthalene 1,5-diisocyanate (NDI), tetramethylxylene diisocyanate (TMXDI), isophorone diisocyanate (IPDI), hydrogenated xylylene diisocyanate (H6XDI), dicyclohexylmethane diisocyanate (H12MDI), hexamethylene diisocyanate (HDI), dimer acid diisocyanate (DDI), norbornene diisocyanate (NBDI), and trimethylhexamethylene diisocyanate (TMDI). These examples may be used alone in combination with PTMG, or may be used in the form of a nurate or the like.

The curing agent is a compound capable of reacting with the prepolymer, such as a diol, a triol, a diamine, or a triamine. Examples of the curing agent include trimethylolpropane (TMP) and diaminodiphenylmethane (DDM). These examples may be used alone, or two or more of the example may be used in combination.

There is no particular limit on the degree of polymerization of PTMG of the prepolymer, which can be selected appropriately for any purpose.

The surface layer according to the present embodiment has a hardness gradient of decrease from the surface toward the lower surface of the base material in the film thickness direction. Such a hardness gradient can be formed, for example, in the following way. The equivalent ratio of the curable composition (the equivalent of NCO groups in the prepolymer/the equivalent of NH₂ groups and OH groups in the curing agent) is designed to be higher than 1, and the isocyanurate bonds in the curable composition is increased with the use of the excess NCO groups to increase the crosslink density. Accordingly, the hardness of the surface layer according to the present embodiment can be increased. If the isocyanurate bond is uniformly increased throughout the curable composition, there is a possibility that the entire composition may be excessively hardened, and then brittle. Therefore, according to the present embodiment, the amount of the isocyanurate bond of the curable composition in the surface layer on the side closer to the surface is preferably larger than the amount of the isocyanurate bond on the side closer to the lower surface of the base material. Forming the surface layer as described above makes it possible to obtain a hardness gradient of decrease from the surface toward the lower surface of the base material in the film thickness direction. The surface layer on the side closer to the lower surface of the base material has hardness closer to the hardness of the soft base material, and has qualities such as followability stabilized as a blade. In order to increase the amount of isocyanurate bond of the curable composition on the side closer to the surface in the surface layer, for example, the curable composition may be applied to the base material, and then left to stand for several days under a high-temperature and high-humidity environment such as 45° C./90% RH to complete the reaction of the excess NCO group, thereby causing the cyanurization on the side closer to the surface of the surface layer to proceed greatly than on the side closer to the lower surface of the base material.

The siloxane-based compound in the surface layer can be selected appropriately for any purpose, but is preferably a modified silicone oil. The use of a modified silicone oil reduces the friction coefficient of the blade, and reduces the frictional force in sliding to suppress wear of the blade, and further achieve the effect of stabilizing the behavior of the blade tip in sliding. In addition, in the form of using a polyurethane-based compound, the use of a modified silicone oil can promote the stabilization of the behavior of the blade tip, because the polyurethane-based compound is typically hard.

The polyurethane-based compound and the modified silicone oil preferably form a sea-island structure including a sea of the polyurethane-based compound and an island of the modified silicone oil. More specifically, the surface layer preferably has a sea-island structure including a sea part containing the polyurethane-type compound, and an island part containing the modified silicone oil. Having the sea-island structure makes it possible to the features of both components of the sea part and the island part, and makes it possible to further stabilize the behavior of the tip ridge of the cleaning blade, as compared with case of not having the sea-island structure.

Examples of the modified silicone oil include polyether-modified silicone oils and alkyl-modified silicone oils, and commercially available modified silicone oils can be used, which include SH8400 (polyether-modified silicone oil manufactured by Dow Corning Toray Co., Ltd.), FZ-2110 (polyether-modified silicone oil manufactured by Dow Corning Toray Co., Ltd.), SF8416 (alkyl-modified silicone oil Dow Corning Toray Co., Ltd.), SH3773M (polyether-modified silicone oil manufactured by Dow Corning Toray Co., Ltd.), and X-22-4272 (polyether-modified silicone oil manufactured by Shin-Etsu Silicone).

The content of the siloxane-based compound in the surface layer is, for example, 4 to 15% by mass, preferably 8 to 15% by mass, and more preferably 8 to 10% by mass.

In a method for determining the quantity of the modified silicone oil in the surface layer, the sample (obtained by cutting out the blade tip) is immersed in cyclohexane, stirred, and left to stand. The solid content after removal of the supernatant liquid by centrifugation is newly added with cyclohexane, stirred, and left to stand. This operation is repeated to completely remove the modified silicone oil in the sample. The quantity of the modified silicone oil in the surface layer is determined from the weight change of the sample.

The surface layer according to the present embodiment preferably has a hardness gradient where the Martens hardness HM measured with the use of a nano indenter decreases from the surface toward the lower surface of the base material in the film thickness direction, from the viewpoint of improving the advantageous effect of the present embodiment. The measurement points for the Martens hardness HM are at least two points of the vicinity of the surface of the surface layer and the deepest part in the film thickness direction of the surface layer, and it is suitable to measure the Martens hardness HM also at a middle point between these measurement points. The Martens hardness (HM) of the surface layer can be measured by the same method as the method for measuring Martens hardness (HM) of the base material. The “Martens hardness HM in the vicinity of the surface of the surface layer” is measured by pushing a Berkovich indenter with a load of 1 μN for 10 seconds, holding the indenter for 5 seconds, and pulling the indenter for 10 seconds with the same load. Similarly, the “Martens hardness HM at the deepest part in the film thickness direction of the surface layer” is measured by pushing a Berkovich indenter with a load of 1000 μN for 10 seconds, holding the indenter for 5 seconds, and pulling the indenter for 10 seconds with the same load. In addition, the “Martens hardness HM at the middle point” is measured by pushing a Berkovich indenter with a load of 50 μN for 10 seconds, holding the indenter for 5 seconds, and pulling the indenter for 10 seconds with the same load.

The Martens hardness HM of the surface layer according to the present embodiment is preferably 2.5 to 32.5 N/mm², more preferably 4.0 to 21.0 N/mm², in the range from the vicinity of the surface (with a load of 1 μN) to the deepest part in the film thickness direction (with a load of 1000 μN). Specifically, the Martens hardness HM in the vicinity of the surface (with a load of 1 μN) of the surface layer according to the present embodiment is preferably 7.5 to 32.5 N/mm², more preferably 17.0 to 21.0 N/mm². The Martens hardness HM at the deepest part (with a load of 1000 μN) in the film thickness direction of the surface layer according to the present embodiment is preferably 2.5 to 9.5 N/mm², more preferably 3.5 to 5.0 N/mm². The Martens hardness HM at the middle point (with a load of 50 μN) of the surface layer according to the present embodiment is preferably 4.0 to 18.0 N/mm², more preferably 7.0 to 12.0 N/mm².

Furthermore, the creep CIT of the surface layer according to the present embodiment, measured with the use of the nano indenter, has a gradient of decrease from the surface toward the lower surface of the base material in the film thickness direction, from the viewpoint of improving the advantageous effect of the present embodiment. The creep CIT is preferably 3.0 to 13.5%, more preferably 5.0 to 12.0%, in the range from the vicinity of the surface (with a load of 1 μN) to the deepest part (with a load of 1000 μN) in the film thickness direction. Specifically, the creep CIT in the vicinity of the surface (with a load of 1 μN) of the surface layer according to the present embodiment is preferably 9.5 to 13.5%, more preferably 9.5 to 12.0%. The creep CIT at the deepest part (with a load of 1000 μN) in the film thickness direction of the surface layer according to the present embodiment is preferably 3.0 to 7.5%, more preferably 3.0 to 6.5%. The creep CIT at the middle point (with a load of 50 μN) of the surface layer according to the present embodiment is preferably 6.0 to 11.0%, more preferably 6.0 to 9.5%.

The cleaning blade 62 according to the present embodiment can prevent the tip ridge 62c in contact with the surface of the cleaning target member of the elastic member from being turned up, to make the tip ridge 62c of the elastic member less likely to be worn in use. Thus, favorable cleaning performance can be maintained over a long period of time. Accordingly, although the cleaning blade 62 can be widely used in various fields, the cleaning blade 62 is particularly suitably used for the process cartridge and image forming apparatus described below.

(Process Cartridge, Image Forming Apparatus, and Image Forming Method)

The process cartridge according to an embodiment of the present invention includes at least an image bearer and a cleaning means for removing a toner remaining on the image bearer, and the cleaning means includes the cleaning blade according to an embodiment of the present invention. A mechanism for applying a lubricant to the surface of the latent image bearer may be provided as a cleaning assistant means.

The image forming apparatus according to an embodiment of the present invention includes an image bearer, a charging means for charging the surface of the image bearer, an exposure means for exposing the charged image bearer to form an electrostatic latent image, a developing means for developing the electrostatic latent image with a toner to form a visible image, a transfer means for transferring the visible image to a recording medium, a fixing means for fixing the transfer image transferred to the recording medium, and a cleaning means for removing the toner remaining on the image bearer, and the cleaning blade according to an embodiment of the present invention is used as the cleaning means. The image bearer may be provided, as a cleaning assistant means, with a mechanism for applying a lubricant to the image bearer.

Hereinafter, an embodiment (hereinafter, referred to as the embodiment) of an electrophotographic printer (hereinafter, simply referred to as a printer 500) will be described as an image forming apparatus to which an embodiment of the present invention is applied. First, the basic configuration of the printer 500 according to the present embodiment will be described.

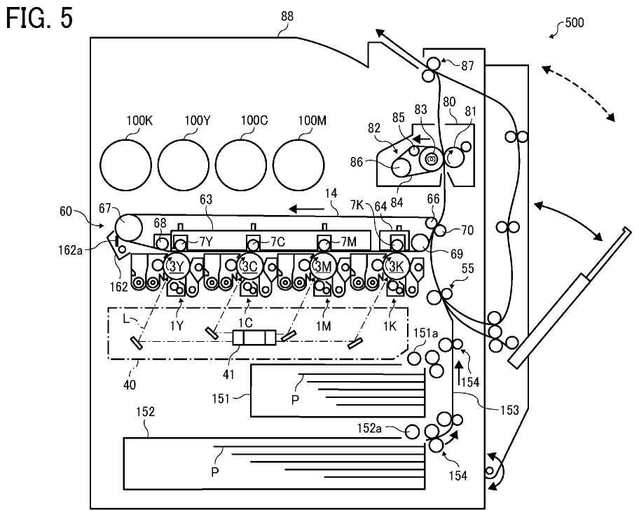

FIG. 5 is a schematic configuration diagram illustrating the printer 500. The printer 500 includes four image formation units 1Y, 1C, 1M, and 1K for yellow, magenta, cyan, and black (hereinafter referred to as Y, C, M, and K). These units use Y, C, M, and K toners that differ in color from each other as image forming substances for forming an image, but have the same configuration except the difference.

Above the four image formation units 1, a transfer unit 60 including an intermediate transfer belt 14 is disposed as an intermediate transfer body. The toner images of the respective colors, formed on the surfaces of photoconductors 3Y, 3C, 3M, and 3K provided in the respective image formation units 1Y, 1C, 1M, and 1K described later in detail are transferred to be superimposed on the surface of the intermediate transfer belt 14.

In addition, an optical writing unit 40 is disposed below the four image formation units 1. The optical writing unit 40 to serve as a latent image forming unit irradiates the photoconductors 3Y, 3C, 3M, and 3K of the respective image formation units 1Y, 1C, 1M, and 1K with laser light L emitted based on image information. Thus, electrostatic latent images for Y, C, M, and K are formed on the photoconductors 3Y, 3C, 3M, and 3K, respectively. It is to be noted that the optical writing unit 40 deflects the photoconductors 3Y, 3C, 3M, and 3K with the laser light L emitted from a light source via a plurality of optical lenses and mirrors, while deflecting the laser light L by a polygon mirror 41 rotationally driven by a motor. Instead of this configuration, a configuration can be also employed which performs light scanning with a light-emitting diode (LED) array.

Below the optical writing unit 40, a first sheet feeding cassette 151 and a second sheet feeding cassette 152 are disposed to overlap in the vertical direction. In each of these sheet feeding cassettes, a plurality of transfer sheets P, which is recording media, is housed in the form of a bundle of stacked sheets, with the topmost transfer sheets P in contact with a first sheet feeding roller 151a and a second sheet feeding roller 152a. When the first sheet feeding roller 151a is rotationally driven counterclockwise in the drawing by a driving means, the topmost transfer sheet P in the first sheet feeding cassette 151 is discharged toward a sheet feeding path 153 disposed to extend in the vertical direction on the right side of the cassette in the drawing. In addition, when the second sheet feeding roller 152a is rotationally driven counterclockwise in FIG. 5 by a driving means, the topmost transfer sheet P in the second sheet feeding cassette 152 is discharged toward the sheet feeding path 153.

In the sheet feeding path 153, a plurality of conveyance roller pairs 154 is disposed. The transfer sheet P fed into the sheet feeding path 153 is conveyed from the lower side to the upper side in FIG. 5 in the sheet feeding path 153 while being sandwiched between the rollers of the conveyance roller pairs 154.

At the downstream end of the sheet feeding path 153 in the conveyance direction, a registration roller pair 55 is disposed. The registration roller pair 55 temporarily stops the rotation of the both rollers, as soon as the registration roller pair 55 sandwiches, between the rollers, the transfer sheet P fed from the conveyance roller pair 154. Then, the registration roller pair 55 feeds the transfer sheet P to a secondary transfer nip described later at an appropriate timing.

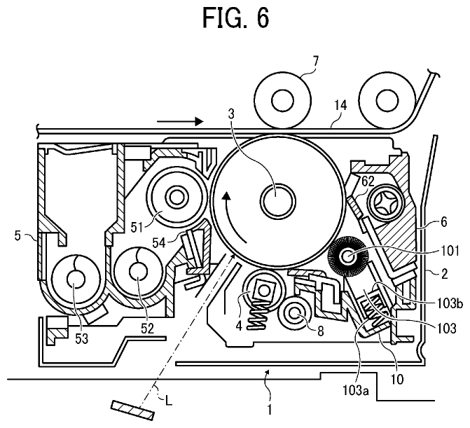

FIG. 6 is a configuration diagram illustrating a schematic configuration of one of the four image formation units 1. As illustrated in FIG. 6, the image formation unit 1 includes the drum-shaped photoconductor 3 as an image bearer. The photoconductor 3 has a drum shape, but may have a sheet shape or an endless belt type. Around the photoconductor 3, a charging roller 4, a developing device 5, a primary transfer roller 7, a cleaning device 6, a lubricant applying device 10, a neutralization lamp, and the like are disposed. The charging roller 4 is a charging member provided in a charging device as a charging means, and the developing device 5 is a developing means for making a latent image formed on the surface of the photoconductor 3 into a toner image. The primary transfer roller 7 is a primary transfer member provided in a primary transfer device as a primary transfer means for transferring the toner image on the surface of the photoconductor 3 to the intermediate transfer belt 14. The cleaning device 6 is a cleaning means for cleaning the toner remaining on the photoconductor 3 after the toner image is transferred to the intermediate transfer belt 14. The lubricant applying device 10 is a lubricant application means for applying a lubricant onto the surface of the photoconductor 3 subjected to cleaning by the cleaning device 6. The neutralization lamp is a neutralizing means for removing the surface potential of the cleaned photoconductor 3.

The charging roller 4 is disposed in a non-contact manner with the photoconductor 3 at a predetermined distance, and charges the photoconductor 3 to a predetermined polarity and a predetermined potential. The surface of the photoconductor 3 uniformly charged by the charging roller 4 is irradiated with the laser light L based on image information from the optical writing unit 40 which is a latent image forming unit, to form an electrostatic latent image.

The developing device 5 has a developing roller 51 as a developer bearer. A developing bias is applied to the developing roller 51 from a power source. In a casing of the developing device 5, a supply screw 52 and a stirring screw 53 are provided for stirring the developer contained in the casing while conveying the developer in opposite directions. In addition, a doctor 54 is also provided for regulating the developer borne on the developing roller 51. The toner in the developer stirred and conveyed by the two screws of the supply screw 52 and the stirring screw 53 is charged to a predetermined polarity. Then, the developer is pumped up onto the surface of the developing roller 51, and the pumped developer is regulated by the doctor 54, and the toner adheres to the latent image on the photoconductor 3 in the developing region facing the photoconductor 3.

The cleaning device 6 has a fur brush 101, the cleaning blade 62, and the like. The cleaning blade 62 makes in contact with the photoconductor 3 in the counter direction with respect to the surface movement direction of the photoconductor 3. It is to be noted that the cleaning blade 62 serves as a cleaning blade according to an embodiment of the present invention. The lubricant applying device 10 includes a solid lubricant 103, a lubricant pressing spring 103a, and the like, and uses the fur brush 101 as an application brush for applying the solid lubricant 103 onto the photoconductor 3. The solid lubricant 103 is held by a bracket 103b and pressed against the fur brush 101 by the lubricant pressing spring 103a. Then, the solid lubricant 103 is scraped off by the fur brush 101 rotating in the rotational direction in accordance with the rotational direction of the photoconductor 3 to apply the lubricant onto the photoconductor 3. The friction coefficient of the surface of the photoconductor 3 is preferably maintained at 0.2 or less in the non-image formation by the lubricant application to the photoconductor.

The charging device according to the present embodiment employs a non-contact close arrangement method in which the charging roller 4 is brought close to the photoconductor 3, but as the charging device, known configurations can be used, including corotron, scorotron, and solid chargers (solid state chargers). Among these charging methods, in particular, a contact charging method or a non-contact close arrangement method is more desirable, which has advantages such as the increased charging efficiency and the reduced ozone generation, and enabling reduction in the size of the device.

For the light source for the laser light L in the optical writing unit 40 and the light source such as the neutralization lamp, general luminescent substances can be used, such as fluorescent lamps, tungsten lamps, halogen lamps, mercury lamps, sodium lamps, light-emitting diodes (LED), semiconductor lasers (LD), and electrolumi-nescence (EL). In addition, in order to emit light in a desired wavelength range alone, various filters can be also used, such as a sharp cut filter, a band pass filter, a near-infrared cut filter, a dichroic filter, an interference filter, and a color temperature conversion filter. Among these light sources, the light-emitting diodes and the semiconductor lasers are used favorably, because the diodes and lasers have high irradiation energy and have light with a long wavelength of 600 to 800 nm.

The transfer unit 60 to serve as a transfer means includes a belt cleaning unit 162, a first bracket 63, a second bracket 64, and the like, in addition to the intermediate transfer belt 14. In addition, the transfer unit 60 also includes four primary transfer rollers 7Y, 7C, 7M, and 7K, a secondary transfer backup roller 66, a drive roller 67, an auxiliary roller 68, a tension roller 69, and the like. The intermediate transfer belt 14 is endlessly moved counterclockwise in the drawing by the rotary drive of the drive roller 67 while being stretched around these eight roller members. The four primary transfer rollers 7Y, 7C, 7M, and 7K sandwich the endlessly moved intermediate transfer belt 14 between the rollers and the photoconductors 3Y, 3C, 3M, and 3K to form primary transfer nips. Then, a transfer bias that has a reverse polarity (for example, plus) with respect to the toner is applied to the back surface (the inner peripheral surface of the loop) of the intermediate transfer belt 14. In the process of sequentially passing through the primary transfer nips for Y, C, M, and K in accordance with the endless movement of the intermediate transfer belt 14, the Y, C, M, and K toner images on photoconductors 3Y, 3C, 3M, and 3K are superimposed and then primarily transferred onto the front surface of the intermediate transfer belt 14. Thus, a four-color superimposed toner image (hereinafter, referred to as a four-color toner image) is formed on the intermediate transfer belt 14.

The secondary transfer backup roller 66 sandwiches the intermediate transfer belt 14 between the roller 66 and a secondary transfer roller 70 disposed outside the loop of the intermediate transfer belt 14 to form a secondary transfer nip. The registration roller pair 55 described previously feeds the transfer sheet P sandwiched between the rollers, toward the secondary transfer nip, at the timing capable of taking synchronization with the four-color toner image on the intermediate transfer belt 14. The four-color toner image on the intermediate transfer belt 14 is collectively secondarily transferred to the transfer sheet P in the secondary transfer nip, under the influence of the secondary transfer electric field formed between the secondary transfer roller 70 to which a secondary transfer bias is applied and the secondary transfer backup roller 66, and the nip pressure. Then, the four-color toner image is combined with the white color of the transfer sheet P to provide a full-color toner image.

The residual transfer toner which has not been transferred to the transfer sheet P adheres to the intermediate transfer belt 14 after passing through the secondary transfer nip. This toner is cleaned by the belt cleaning unit 162. It is to be noted that the belt cleaning unit 162 has a belt cleaning blade 162a in contact with the front surface of the intermediate transfer belt 14. Thus, the belt cleaning unit 162 scrapes off and then remove the residual transfer toner on the intermediate transfer belt 14.

The first bracket 63 of the transfer unit 60 is adapted to swing at a predetermined rotation angle around the rotation axis line of the auxiliary roller 68 as solenoid driving is turned on and off. In the case of forming a monochrome image, the printer 500 just slightly rotates the first bracket 63 counterclockwise in the drawing by the previously described solenoid driving. This rotation causes the primary transfer rollers 7Y, 7C, and 7M for Y, C, and M to revolve around the rotation axis line of the auxiliary roller 68 counterclockwise in the drawing to separate the intermediate transfer belt 14 from the photoconductors 3Y, 3C, and 3M for Y, C, and M. Then, among the four image formation units 1Y, 1C, 1M, and 1K, the image formation unit 1K for K is singly driven to form a monochrome image. Thus, it is possible to avoid the consumption of each member including the image formation unit 1 due to the image formation units 1 for Y, C, and M driven wastefully in the monochrome image formation.

Above the secondary transfer nip in the drawing, a fixing unit 80 is disposed. The fixing unit 80 includes a pressurizing heating roller 81 including a heat generation source such as a halogen lamp, and a fixing belt unit 82. The fixing belt unit 82 has a fixing belt 84 to serve as a fixing member, a heating roller 83 including a heat generation source such as a halogen lamp, a tension roller 85, a drive roller 86, a temperature sensor, and the like. While stretching the endless fixing belt 84 by the heating roller 83, the tension roller 85, and the drive roller 86, the endless fixing belt 84 is endlessly moved in the counterclockwise direction in the drawing. In the process of this endless movement, the fixing belt 84 is heated from the back side by the heating roller 83. The pressurizing heating roller 81, which is driven to rotate clockwise in the drawing, makes, from the front side, contact with the fixing belt 84 heated as described above around the heating roller 83. Thus, a fixing nip is formed where the pressurizing heating roller 81 comes into contact with the fixing belt 84.

Outside the loop of the fixing belt 84, a temperature sensor is disposed so as to face the front surface of the fixing belt 84 with a predetermined gap interposed between the temperature sensor and the front surface, and the temperature sensor detects the surface temperature of the fixing belt 84 just before entering the fixing nip. The detection result is sent to a fixing power circuit. The fixing power circuit performs, based on the result of the detection by the temperature sensor, on/off control of the supply of power for the heat generation source included in the heating roller 83 and the heat generation source included in the pressurizing heating roller 81.

The transfer sheet P, which has passed through the secondary transfer nip described above, is separated from the intermediate transfer belt 14, and then fed into the fixing unit 80. Then, in the process of being conveyed from the lower side to the upper side in the drawing while being sandwiched by the fixing nip in the fixing unit 80, the full-color toner image is heated and pressed by the fixing belt 84 to be fixed on the transfer sheet P.

The transfer sheet P thus subjected to the fixing treatment is passed between the rollers of a sheet ejection roller pair 87, and then discharged to the outside of the machine. On the upper surface of the housing for the main body of the printer 500, a stack part 88 is formed, and the transfer sheet P discharged to the outside of the machine by the sheet ejection roller pair 87 is sequentially stacked on the stack part 88.

Above the transfer unit 60, four toner cartridges 100Y, 100C, 100M, and 100K are disposed which respectively contain Y, C, M, and K toners. The Y, C, M, and K toners in the toner cartridges 100Y, 100C, 100M, and 100K are supplied appropriately to the developing devices 5Y, 5C, 5M, and 5K of the image formation units 1Y, 1C, 1M, and 1K, respectively. The toner cartridges 100Y, 100C, 100M, and 100K are removable from the printer main body independently of the image formation units 1Y, 1C, 1M, and 1K.

Next, an image forming operation in the printer 500 will be described. When a signal for printing execution is received from an operation unit or the like, predetermined voltages or currents are sequentially applied at predetermined timings to the charging roller 4 and the developing roller 51. Similarly, predetermined voltages or currents are also sequentially applied at predetermined timings to the optical writing unit 40 and light sources such as the neutralization lamp. In addition, in synchronization with the foregoing application, the photoconductor 3 is rotationally driven in the direction of an arrow in the drawing by a photoconductor driving motor as a driving means.

When the photoconductor 3 is rotated in the direction of the arrow in the drawing, first, the surface of the photoconductor 3 is uniformly charged by the charging roller 4 to a predetermined potential. Then, the photoconductor 3 is irradiated with the laser light L corresponding to image information from the optical writing unit 40 to neutralize the part irradiated with the laser light L on the surface of the photoconductor 3, and an electrostatic latent image is formed.

The surface of the photoconductor 3 with the electrostatic latent image formed is rubbed by a magnetic brush of a developer formed on the developing roller 51 in a section facing the developing device 5. In this regard, the negatively charged toner on the developing roller 51 is moved to the electrostatic latent image side by a predetermined developing bias applied to the developing roller 51, to form (develop) a toner image. Similar image formation processes are performed in the respective image formation units 1 to form toner images of the respective colors on the surfaces of the respective photoconductors 3Y, 3C, 3M, and 3K of the respective image formation units 1Y, 1C, 1M, and 1K.

As described above, in the printer 500, the electrostatic latent image formed on the photoconductor 3 is reversely developed with the negatively charged toner by the developing device 5. In the present embodiment, an example of using the non-contact charging roller method of N/P (negative-positive: toners adhering to sites lower in potential) has been described, but the present invention is not to be considered limited to the example.

The toner images of the respective colors, formed on the surfaces of the respective photoconductors 3Y, 3C, 3M, and 3K are sequentially primarily transferred so as to overlap on the surface of the intermediate transfer belt 14. Thus, a four-color toner image is formed on the intermediate transfer belt 14.

The four-color toner image formed on the intermediate transfer belt 14 is transferred onto the transfer sheet P fed from the first sheet feeding cassette 151 or the second sheet feeding cassette 152, passed between the rollers of the registration roller pair 55, and fed to the secondary transfer nip. In this regard, the transfer sheet P sandwiched by the registration roller pair 55 is temporarily stopped, and in synchronization with the leading end of the image on the intermediate transfer belt 14, the transfer sheet P is supplied to the secondary transfer nip. The transfer sheet P with the toner image transferred is separated from the intermediate transfer belt 14, and conveyed to the fixing unit 80. Then, when the transfer sheet P with the toner image transferred passes through the fixing unit 80, the toner image is fixed on the transfer sheet P by the action of heat and pressure, and the transfer sheet P with the toner image fixed is discharged to the outside of the apparatus of the printer 500, and stacked on the stack part 88.

On the other hand, from the surface of the intermediate transfer belt 14 which has transferred the toner image to the transfer sheet P at the secondary transfer nip, the residual transfer toner on the surface is removed by the belt cleaning unit 162. Further, from the surface of the photoconductor 3 which has transferred the toner images of the respective colors to the intermediate transfer belt 14 at the primary transfer nip, the residual toner after the transfer is removed by the cleaning device 6, the lubricant is applied to intermediate transfer belt 14 by the lubricant applying device 10, and the intermediate transfer belt 14 is neutralized by the neutralization lamp.

As illustrated in FIG. 6, the image formation unit 1 of the printer 500 has the photoconductor 3, and as a process means, the charging roller 4, the developing device 5, the cleaning device 6, the lubricant applying device 10, etc., housed in a frame 2. The image formation unit 1 is, as a process cartridge, integrally removable from the main body of the printer 500. In the printer 500, the image formation unit 1 is adapted to integrally replace the photoconductor 3 as a process cartridge and the process means, but may be adapted to be replaced with new photoconductor and a process means in a unit such as the photoconductor 3, the charging roller 4, the developing device 5, the cleaning device 6, or lubricant applying device 10.

Next, a toner suitable for the printer 500 to which an embodiment of the present invention is applied will be described. As the toner for use in the printer 500, in order to improve the image quality, it is suitable to use a polymerization toner produced by a suspension polymerization method, an emulsion polymerization method, or a dispersion polymerization method, which easily increases the circularity and reduces the particle size. In particular, it is suitable to use a polymerization toner of 0.97 or more in circularity and of 5.5 μm or less in volume average particle size. The use of the toner of 0.97 or more in average circularity and of 5.5 μm in volume average particle diameter can form higher-resolution images.

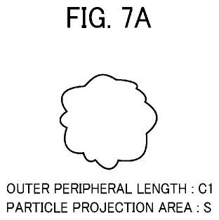

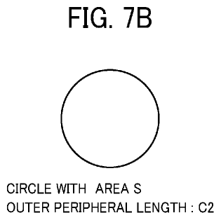

The term “circularity” herein refers to the average circularity measured by a flow-type particle image analyzer FPIA-2000 (manufactured by Toa Medical Electronics Co., Ltd.). Specifically, to 100 to 150 ml of water with impure solid substances removed in advance in a container, 0.1 to 0.5 ml of a surfactant, preferably an alkylbenzene sulfonate, is added as a dispersant, and approximately 0.1 to 0.5 g of a measurement sample (toner) is further added. Thereafter, the suspension with the toner dispersed is subjected to a dispersion treatment for about 1 to 3 minutes with an ultrasonic disperser, such that the dispersion liquid concentration reaches 3000 to 10000 [/μl], and set in the analyzer described above to measure the shape and distribution of the toner. Then, based on the measurement result, the ratio of C2/C1 was obtained where C1 represents the outer peripheral length of an actual toner projected shape illustrated in FIG. 7A, S represents the projected area of the toner, and C2 represents the outer peripheral length of a perfect circle illustrated in FIG. 7B, which has the same projected area S, and the average value was regarded as the circularity.

It is possible to determine the volume average particle size by a Coulter counter method. Specifically, the data of the number distribution and volume distribution of the toner measured by Coulter Multisizer 2e (manufactured by Coulter) is transmitted to a personal computer via an interface (manufactured by Nikkaki Co., Ltd.), and then analyzed. A specific example of the analysis method will be described. A 1% NaCl aqueous solution that uses first-grade sodium chloride is prepared as an electrolytic solution. Then, 0.1 to 5 ml of a surfactant, preferably an alkylbenzene sulfonate, is added as a dispersant to 100 to 150 ml of the electrolytic aqueous solution. Furthermore, 2 to 20 mg of the toner as a test sample is added to the solution, and the solution with the toner added is subjected to a dispersion treatment for about 1 to 3 minutes with an ultrasonic disperser. Then, 100 to 200 ml of the electrolytic aqueous solution is put in another beaker, and the solution subjected to the dispersion treatment is added to the solution so as to reach a predetermined concentration, and then subjected to the measurement by the Coulter Multisizer 2e. With the use of an aperture of 100 μm, the particle sizes of 50,000 toner particles are measured. As a channel, 13 channels of: 2.00 μm or more and less than 2.52 μm; 2.52 μm or more and less than 3.17 μm; 3.17 μm or more and less than 4.00 μm; 4.00 μm or more and less than 5.04 μm; 5.04 μm or more and less than 6.35 μm; 6.35 μm or more and less than 8.00 μm; 8.00 μm or more and less than 10.08 μm; 10.08 μm or more and less than 12.70 μm; 12.70 μm or more and less than 16.00 μm; 16.00 μm or more and less than 20.20 μm; 20.20 μm or more and less than 25.40 μm; 25.40 μm or more and less than 32.00 μm; and 32.00 μm or more and less than 40.30 μm are used, and toner particles of 2.00 μm or more and less than 32.0 μm in particle size are subjected to the measurement.

Then, the volume average particle size is calculated, based on the relational expression “Volume Average Particle Size=ΣXfV/ΣfV”. In the expression, “X” represents a representative diameter in each channel, “V” represents an equivalent volume with the representative diameter for each channel, and “f” represents the number of particles in each channel.

As for such a polymerization toner, even when an attempt is made to remove the ground toner with the cleaning blade 62 in the same manner as in the case of removing the conventional ground toner from the surface of the photoconductor 3, the polymerization toner is not completely removed from the surface of the photoconductor 3, and defective cleaning is caused. In addition, recent low-temperature fixing toners that uses a crystalline resin are largely deformed in slipping through the blade, adhere to the ridge of the blade or are fused to the surface of the photoconductor. When the contact pressure of the cleaning blade 62 to the photoconductor 3 is increased to enhance the cleaning performance, there is a disadvantage that the cleaning blade 62 will wear out early.

Further, with the increased frictional force between the cleaning blade 62 and the photoconductor 3, the tip ridge of the cleaning blade 62 in contact with the photoconductor 3 is pulled in the moving direction of the photoconductor 3, and the tip ridge is turned up. When the tip ridge of the cleaning blade 62 is turned up, various disad-vantages occur such as abnormal noise, vibration, and tip ridge missing. The cleaning blade according to an embodiment of the present invention causes no defective cleaning, even in the case of the polymerization toner as described above, and no abnormal noise, vibration, tip ridge missing, or the like is caused.

### EXAMPLES

Examples of the present invention will be described below, but the present invention is not to be considered limited to these examples in any way.

As the base material of the elastic member, a urethane rubber with the following JIS-A hardness, 23° C. impact resilience modulus, and Martens hardness (HM) was prepared by centrifugal molding. JIS-A hardness: 75°; 23° C. impact resilience modulus: 45%; Martens hardness (HM): 0.9 N/mm²

Here are the measurement methods.

<JIS-A Hardness of Base Material>

The JIS-A hardness of the lower surface of the base material of the elastic member was measured in conformity with JIS K6253 with the use of a micro rubber hardness meter MD-1 manufactured by Kobunshi Keiki Co., Ltd. (23° C.).

<Impact Resilience Modulus of Base Material>

The impact resilience modulus of the base material of the elastic member was measured in accordance with JIS K6255 at 23° C. with the use of a No. 221 resilience tester manufactured by Toyo Seiki Seisaku-sho, Ltd. As a sample, stacked sheets each with a thickness of 2 mm were used so as to reach a thickness of 4 mm or more.

<Martens Hardness of Base Material>

The Martens hardness (HM) of the base material was measured in accordance with the method described above.

<Surface Layer Formation>

Here are the materials used for the curable composition for forming the surface layer. —Isocyanate—

MDI (4,4′-diphenylmethane diisocyanate): “Millionate MT” manufactured by Tosoh Corporation

Hydrogenated MDI (dicyclohexylmethane 4,4′-diisocyanate): manufactured by Tokyo Chemical Industry Co., Ltd.

TDI (2,4-tolylene diisocyanate): “Coronate T-100” manufactured by Tosoh Corporation —Polyol—

PTMG (polytetramethylene ether glycol): “PTMG1000” “PTMG2000”, “PTMG3000” manufactured by Mitsubishi Chemical Corporation —Curing Agent—

DDM (4,4′-diaminodiphenylmethane): manufactured by Tokyo Chemical Industry Co., Ltd.

TMP (trimethylolpropane): manufactured by Mitsubishi Gas Chemical Company, Inc. —Catalyst—

Dioctyltin dilaurate: “NEOSTANN U-810” manufactured by Nitto Kasei Co., Ltd. —Siloxane-based Compound—

SH8400: Toray Industries, Inc.

Polyether-modified silicone oil manufactured by Dow Corning Corporation

FZ-2110: Toray Industries, Inc.

Polyether-modified silicone oil manufactured by Dow Corning Corporation

SF 8416: Toray Industries, Inc.

Alkyl-modified silicone oil manufactured by Dow Corning Corporation —Synthesis of Prepolymer with NCO Groups at Both Terminals—

As illustrated in Table 1 below, an isocyanate and a polyol were mixed so as to reach desired NCO %, and reacted with stirring at 80° C. for 180 minutes under a nitrogen purge to prepare prepolymers 1 to 4 of with NCO groups at both terminals.

TABLE 1

| | Isocyanate | Polyol | NCO (%) |
|---|---|---|---|
| Prepolymer 1 | MDI | PTMG3000 | 7.5 |
| Prepolymer 2 | Hydrogenated MDI | PTMG2000 | 3.9 |
| Prepolymer 3 | TDI | PTMG2000 | 2.4 |
| Prepolymer 4 | Hydrogenated MDI | PTMG1000 | 11.5 |

—Preparation of Curable Composition—

The above-mentioned prepolymers 1 to 4, the curing agent, and the catalyst, the siloxane-based compound were mixed (parts by mass) at room temperature for 3 minutes at 100 rpm with the use of a stirring blade under a vacuum atmosphere, for sufficient degassing, so as to reach the equivalent ratio (the equivalent of NCO groups in the prepolymer/the equivalent of NH₂ groups and OH groups in the curing agent) illustrated in Tables 2 and 3. Curable compositions were thus prepared. It is to be noted that the curing agents were used after diluting the curing agents with methyl ethyl ketone (MEK), such that the solid content of DDM was 40%, whereas the solid content of TMP was 10%. In addition, according to Example 9, the prepolymer and the siloxane-based compound were stirred at 600 rpm for 1 minute for both rotation and revolution with the use of a planetary stirrer. Thereafter, under a vacuum atmosphere, the curing agent and the catalyst were mixed at room temperature for 3 minutes at 100 rpm with the use of a stifling blade, for sufficient degassing. Curable compositions were thus prepared.

TABLE 2

| | | Example | | | | | | | | |
|---|---|---|---|---|---|---|---|---|---|---|
| Material | | 1 | 2 | 3 | 4 | 5 | 6 | 7 | 8 | 9 |
| Prepolymer | 1 | 100 | — | — | — | — | — | — | — | — |
| | 2 | — | 100 | 100 | 100 | — | 100 | — | 100 | 100 |
| | 3 | — | — | — | — | 100 | — | — | — | — |
| | 4 | — | — | — | — | — | — | 100 | — | — |
| Curing | DDM | 15.2 | 25.4 | 20.7 | 18.5 | 7.5 | 9 | 45 | 25.4 | 25.4 |
| Agent | TMP | 39 | — | — | 3.8 | 12 | 26 | — | — | — |
| Catalyst | Dioctyltin | 3 | 3 | 3 | 3 | 3 | 3 | 3 | 3 | 3 |
| | Dilaurate | | | | | | | | | |
| Siloxane- | SH8400 | — | — | 10 | — | — | — | — | — | — |
| based | FZ-2110 | — | 20 | — | — | 15 | — | — | 5 | 20 |
| Compound | SF8416 | 20 | — | — | 10 | — | 10 | 20 | — | — |

| | | | | | | | | | |
|---|---|---|---|---|---|---|---|---|---|
| Equivalent Ratio | 1.2 | 0.9 | 1.1 | 1.1 | 1.0 | 1.0 | 1.5 | 1.1 | 0.9 |

TABLE 3

| | | Comparative Example | | | | | |
|---|---|---|---|---|---|---|---|
| Material | | 1 | 2 | 3 | 4 | 5 | 6 |
| Prepolymer | 1 | — | — | — | — | — | — |
| | 2 | — | 100 | — | — | 100 | 100 |
| | 3 | — | — | — | 100 | — | — |
| | 4 | — | — | 100 | — | — | — |
| Curing | DDM | — | 25.4 | 52 | 9 | 25.4 | 25.4 |
| Agent | TMP | — | — | — | 26 | — | — |
| Catalyst | Dioctyltin | — | 3 | 3 | 3 | 3 | 3 |
| | Dilaurate | | | | | | |
| Siloxane- | SH8400 | — | — | | — | — | 4 |
| based | FZ-2110 | — | — | 15 | — | 25 | — |
| Compound | SF8416 | — | — | — | 10 | — | — |

| | | | | | | |
|---|---|---|---|---|---|---|
| Equivalent Ratio | — | 0.9 | 1.3 | 0.6 | 0.9 | 0.9 |

<Example of Toner Preparation>—Production of Graft Polymer—

In a reaction container set with a stirring rod and a thermometer, 480 parts by mass of xylene, 100 parts by mass of low-molecular-weight polyethylene (Sanwax LEL-400 manufactured by Sanyo Chemical Industries, Ltd.: softening point 128° C.) were put, and dissolved sufficiently. After nitrogen substitution, a mixed solution of 740 parts by mass of styrene, 100 parts by mass of acrylonitrile, 60 parts by mass of butyl acrylate, 36 parts by mass of di-t-butyl peroxyhexahydroterephthalate, and 100 parts by mass of xylene was delivered by drops into the reaction container at 170° C. for 3 hours for polymerization, and further kept at this temperature for 30 minutes. Then, the solvent was removed to synthesize a [graft polymer]. The obtained [graft polymer] had a weight average molecular weight (Mw) of 24,000, and a glass transition temperature (Tg) of 67° C. —Preparation of Release Agent Dispersion Liquid (1)—

In a container set with a stirring rod and a thermometer, 50 parts by mass of a paraffin wax (manufactured by NIPPON SEIRO CO., LTD., HNP-9, hydrocarbon-based wax, melting point: 75° C., SP value: 8.8), 30 parts by mass of the graft polymer, and 420 parts by mass of an ethyl acetate were put, heated to a temperature of 80° C. with stirring, kept at 80° C. for 5 hours, then cooled to 30° C. in 1 hour, and dispersed under the conditions of liquid sending speed: 1 kg/hr, disk peripheral speed: 6 m/sec, 80% by volume filling with 0.5 mm zirconia beads, and 3 passes, with the use of a bead mill (Ultravisco mill, manufactured by AIMEX CO., Ltd.) to obtain a [release agent dispersion liquid (1)].

### Production Example 1

(Production of Urethane-Modified Crystalline Polyester Resin A-1)

In a reaction vessel equipped with a cooling pipe, a stirrer, and a nitrogen introduction pipe, 202 parts by mass (1.00 mol) of a sebacic acid, 15 parts by mass (0.10 mol) of an adipic acid, 177 parts by mass (1.50 mol) of 1,6-hexanediol, and 0.5 parts by mass of tetrabutoxytitanate as a condensation catalyst were put, and reacted at 180° C. under a nitrogen stream for 8 hours while distilling off produced water. Then, while raising the temperature gradually to 220° C., the reaction was developed for 4 hours while distilling off produced water and 1,6-hexanediol under a nitrogen stream, and further developed under a reduced pressure of 5 to 20 mmHg until Mw reached approximately 12,000, to obtain a [crystalline polyester resin A′-1]. The obtained [crystalline polyester resin A′-1] had a Mw of 12,000.

Subsequently, the obtained [crystalline polyester resin A′-1] was transferred into a reaction vessel equipped with a cooling pipe, a stirrer, and a nitrogen introduction pipe, and with the addition of 350 parts by mass of ethyl acetate and 30 parts by mass (0.12 mol) of 4,4′-diphenylmethane diisocyanate (MDI) to the [crystalline polyester resin A′-1], reacted at 80° C. for 5 hours in a nitrogen stream. Subsequently, the ethyl acetate was distilled off under reduced pressure to obtain a [urethane-modified crystalline polyester resin A-1]. The obtained [urethane-modified crystalline polyester resin A-1] had a Mw of 22,000 and a melting point of 62° C. —Preparation of Masterbatch (1)—

100 parts by mass of crystalline polyurethane resin A-1 (binder resin)

100 parts by mass of carbon black (Printex 35, manufactured by Degussa AG) (dibutyl phthalate (DBP) oil absorption: 42 mL/100 g, pH: 9.5)

50 parts by mass of ion exchange water The raw materials mentioned above were mixed with the use of a Henschel mixer (manufactured by Mitsui Mining Co., Ltd.). The obtained mixture was kneaded with the use of a double roll mill. From a kneading temperature of 90° C., the kneading was started, and then gradually cooled down to 50° C. The obtained kneaded material was subjected to grinding with a pulperizer (manufactured by Hosokawa Micron Corporation) to prepare a [masterbatch (1)].

(Production of Non-crystalline Resin C-1)

In a reaction vessel equipped with a cooling pipe, a stirrer, and a nitrogen insertion pipe, 222 parts by mass of bisphenol A-2 mol EO adduct, 129 parts by mass of bisphenol A-2 mol PO adduct, 166 parts by mass of an isophthalic acid, and 0.5 parts by mass of tetrabutoxytitanate were put, and reacted at 230° C. and normal pressure under a nitrogen stream for 8 hours while distilling off produced water. Next, the reaction was developed under a reduced pressure of 5 to 20 mmHg, cooled to 180° C. when the acid value reached 2, and with the addition of 35 parts by mass of a trimellitic anhydride, reacted for 3 hours at normal pressure to obtain a [non-crystalline resin C-1]. The obtained [non-crystalline resin C-1] had a Mw of 8,000 and a glass transition temperature (Tg) of 62° C.

(Production of Crystalline Resin Precursor B′-1)

In a reaction vessel equipped with a cooling pipe, a stirrer, and a nitrogen introduction pipe, 202 parts by mass (1.00 mol) of a sebacic acid, 122 parts by mass (1.03 mol) of 1,6-hexanediol, and 0.5 parts by mass of titanium dihydroxybis(triethanolaminate) as a condensation catalyst were put, and reacted at 180° C. under a nitrogen stream for 8 hours while distilling off produced water. Then, while raising the temperature gradually to 220° C., the reaction was developed for 4 hours while distilling off produced water and 1,6-hexanediol under a nitrogen stream, and further developed under a reduced pressure of 5 to 20 mmHg until Mw reached approximately 25,000. Thus, a [crystalline resin] was obtained.

The obtained [crystalline resin] was transferred into a reaction vessel equipped with a cooling pipe, a stirrer, and a nitrogen introduction pipe, and with the addition of 300 parts by mass of ethyl acetate and 27 parts by mass (0.16 mol) of hexamethylene diisocyanate (HDI) to the [crystalline resin], reacted at 80° C. for 5 hours under a nitrogen stream to obtain a 50% by mass ethyl acetate solution of a [crystalline resin precursor B′-1] including an isocyanate group at the terminal. 10 parts by mass of the obtained ethyl acetate solution of [crystalline resin precursor B′-1] was mixed with 10 parts by mass of tetrahydrofuran (THF), and with the addition of 1 part by mass of dibutylamine to the mixture, the mixture was stirred for 2 hours. As a result of a GPC measurement with the obtained solution as a sample, the Mw of [crystalline resin precursor B′-1] was 54,000. In addition, as a result of a DSC measurement for a sample obtained by removing the solvent from the solution, the melting point of the [crystalline resin precursor B′-1] was 57° C. —Preparation of Oil Phase (1)—

In a container equipped with a thermometer and a stirrer, 31.5 parts by mass of the [urethane-modified crystalline polyester resin A-1] was put, and with the addition of ethyl acetate in an amount such that the solid content concentration was 50% by mass, dissolved well by heating to at least the melting point of the resin. This solution was, with the addition of 100 parts by mass of a 50% by mass ethyl acetate solution of the [non-crystalline resin C-1], 60 parts by mass of the [release agent dispersion liquid (1)], and 12 parts by mass of the [masterbatch (1)] to the solution, stirred at a rotation number of 5,000 rpm with a TK-type homomixer (manufactured by PRIMIX Corporation) at 50° C., and uniformly dissolved and dispersed to obtain an [oil phase (1′)]. It is to be noted that the temperature of the [oil phase (1′)] was kept at 50° C. in the container, and used within 5 hours from the preparation so as to avoid crystallization.

Next, 25 parts by mass of the ethyl acetate solution of [crystalline resin precursor B′-1] was added to 235 parts by mass of the [oil phase (1′)] kept at 50° C. just before the preparation of a toner base described later. The mixture was stirred at a rotation number of 5,000 rpm with a TK-type homomixer (manufactured by PRIMIX Corporation), and uniformly dissolved and dispersed to prepare an [oil phase (1)]. —Production of Water Dispersion of Resin Microparticles—

In a reaction container set with a stirring rod and a thermometer, 600 parts by mass of water, 120 parts by mass of styrene, 100 parts by mass of a methacrylic acid, 45 parts by mass of a butyl acrylate, 10 parts by mass of sodium alkyl allyl sulfosuccinate (ELEMINOL JS-2 manufactured by Sanyo Chemical Industries, Ltd.), and 1 part by mass of an ammonium persulfate were put, and stirred at 400 rpm for 20 minutes to obtain a white emulsion. The emulsion was heated to a system temperature of 75° C., and reacted for 6 hours. Furthermore, 30 parts by mass of a 1% aqueous solution of ammonium persulfate was added, and the mixture was aged at 75° C. for 6 hours to obtain a [water dispersion of resin microparticles]. The volume average particle size of the particles included in this [water dispersion of resin microparticles] was 80 nm, the weight average molecular weight of the resin component was 160,000, and the Tg was 74° C. —Preparation of Water Phase (1)—

990 parts by mass of water, 83 parts by mass of the [water dispersion of resin microparticles], 37 parts by mass of a 48.5% by weight aqueous solution of sodium dodecyl diphenyl ether disulfonate (ELEMINOL MON-7, manufactured by Sanyo Chemical Industries, Ltd.), and 90 parts by mass of ethyl acetate were mixed and stirred to obtain a [water phase (1)]. —Preparation of Toner Base (1)—

In a separate container set with a stirrer and a thermometer, 520 parts by mass of the [aqueous phase (1)] was put, and then heated to 40° C. To 235 parts by mass of the [oil phase (1′)] kept at 50° C., 25 parts by mass of the ethyl acetate solution of [crystalline resin precursor B′-1] was added. The mixture was stirred at a rotation number of 5,000 rpm with a TK-type homomixer (manufactured by Tokushu Kika Kogyo Co., Ltd.), and uniformly dissolved and dispersed to prepare an [oil phase (1″)]. While stirring the [water phase (1)] kept at 40 to 50° C., at 13,000 rpm with a TK homomixer (manufactured by Tokushu Kika Kogyo Co., Ltd.), the [oil phase (1″)] was added, and emulsified for 1 minute to obtain [emulsified slurry 1].

Then, in a container set with a stirrer and a thermometer, the [emulsified slurry 1] was put, and the solvent was removed at 60° C. for 6 hours to obtain [slurry 1]. The obtained [slurry 1] was filtered under reduced pressure, and then subjected to the following washing treatment.

(1) The filter cake was, with the addition of 100 parts by mass of ion-exchange water to the filter cake, mixed (at a rotation number of 6,000 rpm for 5 minutes) with a TK homomixer, and then filtered.

(2) The filter cake (1) was, with the addition of 100 parts by mass of a 10% by mass aqueous sodium hydroxide solution to the filter cake (1), mixed (at a rotation number of 6,000 rpm for 10 minutes) with a TK homomixer, and then filtered under reduced pressure.

(3) The filter cake (2) was, with the addition of 100 parts by mass of a 10% by mass hydrochloric acid to the filter cake (2), mixed (at a rotation number of 6,000 rpm for 5 minutes) with a TK homomixer, and then filtered.

(4) The filter cake (3) was, with the addition of 300 parts by mass of ion-exchange water to the filter cake (3), mixed (at a rotation number of 6,000 rpm for 5 minutes) with a TK homomixer, and then subjected to a filtering operation twice to obtain a filtration cake (1).

The obtained filter cake (1) was dried at 45° C. for 48 hours in a circulating drier. Thereafter, the dried filter cake (1) was sieved through a 75 μm mesh to prepare a toner base (1). The obtained toner base (1) had an average circularity of 0.98 and a volume average particle size of 4.9 μm.

Next, 1.5 parts by mass of small particle size silica (H2000, manufactured by Clariant), 0.5 part by mass of small particle size titanium oxide (MT-150AI, manufactured by Tayca Corporation), and 1.0 part by mass of large particle size silica (UFP-30H, manufactured by Denki Kagaku Kogyo Co., Ltd.) were added to 100 parts by mass of the toner base (1) to obtain a toner (1). The glass transition temperature of the toner (1) was 50° C.

<Preparation of Cleaning Blades according to Examples and Comparative Examples>

While leaving a part of 4 mm in width from the tip surface of a strip-shaped base material of 1.8 mm in thickness, the lower surface of the base material was masked, and the curable compositions according to the examples and the comparative examples were applied such that surface layers with various average thicknesses were formed on the lower surface of the base material.

Specifically, the entire lower surface of the base material was overcoated by spray coating from the end surface of the base material at a spray gun moving speed of 6 mm/s. Thereafter, the masking was removed, and the base material was heated in a thermostat bath at 90° C. for 1 hour, and then left in a thermostat bath at 45° C./90% RH for 48 hours to complete the reaction. Thereafter, the base material was cut at a site of 1 mm from the end surface to form a contact part.

Next, each elastic member with the surface layer formed on the contact part was secured to a sheet-metal holder (supporting member) with an adhesive so as to be mounted on a color multifunction peripheral (imagio MPC 4500, manufactured by Ricoh Company, Ltd.). As described above, cleaning blades according to the examples and comparative examples were prepared in which the surface layer was formed on the contact part. The cleaning blade according to Example 9 had a sea-island structure including a sea part containing the polyurethane-type compound, and an island part containing the modified silicone oil.

Various properties of the prepared cleaning blades were measured in the following ways. The results are illustrated in Tables 4 and 5.

<Average Film Thickness of Surface Layer>

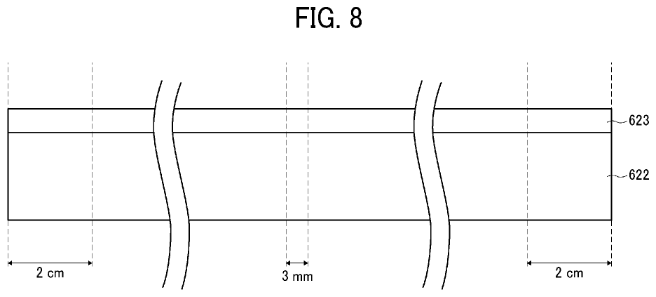

FIG. 8 is a cross-sectional view illustrating the point for measuring the thicknesses of the contact parts of the cleaning blades according to the examples and the comparative examples.

As illustrated in FIG. 8, the elastic member was cut into a round slice in a plane orthogonal to the longitudinal direction, and with the cross section facing upward, observed with a digital microscope VHX-2000 (manufactured by KEYENCE CORPORATION). The measurement point is located at the blade contact part (tip ridge) of the cross section. As a method for cutting the elastic member into the round slice, the elastic member was cut perpendicularly to the longitudinal direction of the elastic member with the use of a razor, such that the thickness was 3 mm in the longitudinal direction of the elastic member. In that regard, the use of a vertical slicer makes it possible to cut the cross section more cleanly. The position in the longitudinal direction where the elastic member was cut into the round slice was located at the position excluding the parts of 2 cm at both ends.

<Martens Hardness HM of Surface Layer>

The Martens hardness (HM) of the surface layer according to each of the examples and comparative examples was measured in the way described above. The measurement position was located at a position of 20 μm in the depth direction from the tip ridge. It is to be noted that the measurement point was set to the position excluding the parts of 2 cm at both ends.

<Dynamic Friction Coefficient μk>

The cleaning blade was pressed against a metallic plate member with a 150 μm-thick PET sheet disposed on the surface of the member (cleaning angle: 79°, linear pressure: 20 g/cm), and the cleaning blade was moved at a speed of 20 mm/s to measure the dynamic friction coefficient μk.

<Assembly of Image Forming Apparatus>

The prepared cleaning blade according to each of the examples and comparative examples was attached to a process cartridge of a color multifunction peripheral (imagio MPC 4500, manufactured by Ricoh Company, Ltd.) (the printer unit has similar configuration as the image forming apparatus 500 illustrated in FIG. 5) to assemble image forming apparatuses according to the examples and the comparative examples.

It is to be noted that the cleaning blade was attached to the image forming apparatus so as to provide the linear pressure: 20 g/cm and the cleaning angle: 79°. In addition, the above-mentioned apparatus includes a lubricant applying device for the surfaces of photoconductors, and the lubricant application maintains the static friction coefficient of the photoconductor surface at 0.2 or less during non-image formation. It is to be noted that as for a method for measuring the static friction coefficient of the photoconductor surface, the static friction coefficient is measured by the method of Euler belt as follows.

Method for Measuring Static Friction Coefficient of Photoconductor Surface

The belt-type measuring member obtained by cutting a medium-thick high-quality paper sheet into a width of 20 mm such that the paper pressing direction was regarded as the longitudinal direction was brought into contact with the outer peripheral part ¼ of the cylindrical photoconductor, and a load (100 g) was applied to one end (lower end) of the measuring member, whereas a force gauge was coupled to the other end. Thereafter, the force gauge was moved at a constant speed (100±20 mm), the value of the force gauge was read when the belt started moving, and the static friction coefficient was calculated from the following formula (1).

μs=2/π×ln(F/W) Formula (1)

In the formula, μs represents a static friction coefficient, F represents a force gauge reading (g), and W represents a load (100 g).

<Durability Test>

The image forming apparatus was used to output 50,000 sheets (horizontal A4 size) under laboratory environment: 65% RH at 21° C., sheet passing condition: 3 prints/job at an image area ratio 5% chart. After passing the 50,000 sheets, various characteristics were evaluated. The results are illustrated in Tables 4 and 5.

<Cleaning Performance>

As evaluation images, 20 sheets of 3 charts with a vertical band pattern (with respect to the paper traveling direction) of 43 mm in width were output in the horizontal A4 size, the obtained images were visually observed, and the cleaning performance was evaluated by the presence or absence of image abnormality due to defective cleaning.

Evaluation Criteria

VERY GOOD: No toner slipping due to defective cleaning can be visually confirmed on either the printed paper or the photoconductor, and no streak-like toner slippage can be confirmed even when the photoconductor was observed with a microscope in the longitudinal direction.

GOOD: No toner slipping due to defective cleaning can be visually confirmed on either the printed paper or the photoconductor.

POOR: The toner slipping due to defective cleaning can be visually confirmed on either the printed paper or the photoconductor.

<Abnormal Noise>

As an abnormal noise evaluation, the presence or absence of any abnormal noise was confirmed by the human ear at the time of the image output for the evaluation of the cleaning performance, to make the following determination. In this regard, even in a case where there was any difference in sound, such as a high frequency or a low frequency, the presence or absence of the sound as an abnormal noise was evaluated without distinction as long as the sound came from the blade.

Evaluation Criteria

GOOD: No abnormal noise generated

POOR: Abnormal noise generated

<Contamination Test (Bleed)>

The cleaning blades according to the examples and comparative examples were attached to the process cartridge of the image forming apparatus (linear pressure: 40 g/cm, cleaning angle:75°), and left to stand in a thermostat bath at 45° C./95% RH for 10 days. Thereafter, five sheets of halftone images were continuously printed with the image forming apparatus under a laboratory environment: 21° C./65% RH, and the image quality was checked.

Evaluation Criteria

VERY GOOD: No defect in the images from the first sheet to the fifth sheet. There is no problem with quality at all.

GOOD: There was an image with streaks in accordance with the photoconductor period on the first sheet, but the colors of the streaks in accordance with photoconductor period were reduced each time the sheet was passed, and there was no streaks on the fifth sheet. There is no quality problem.

POOR: There are streaks in accordance with the photoconductor period on the first sheet to the fifth sheet, and there is even no tendency to reduce the colors of the streaks. There is a quality problem.

<Deformation Test>

The cleaning blades according to the examples and comparative examples were attached to the process cartridge of the image forming apparatus (linear pressure: 40 g/cm, cleaning angle:75°), and left to stand in a thermostat bath at 10° C./15% RH for 10 days. Thereafter, a sheet of a halftone image was printed with the image forming apparatus under a laboratory environment: 21° C./65% RH, and the photoconductor was then visually observed.

Evaluation Criteria

VERY GOOD: No problem with the photoconductor. There is no problem with quality at all.

GOOD: There was a slight streak in the printing direction, but there was no quality problem with the image. Thus, there is no problem.

POOR: The photoconductor has clear streaks in the printing direction, and the image also has streaks at a level that has a problem with quality. It is to be noted that in a case where the blade tip is deformed, the ability to follow the movement of the photoconductor was lost, which causes defective cleaning. As a result, streaks occur.

TABLE 4

| | | Example | | | | | | | | |
|---|---|---|---|---|---|---|---|---|---|---|
| | | 1 | 2 | 3 | 4 | 5 | 6 | 7 | 8 | 9 |
| Average Film Thickness | | 150 | 300 | 200 | 80 | 50 | 500 | 20 | 250 | 300 |
| of Surface Layer (μm) | | | | | | | | | | |
| Martens | Load: 1 μN | 26.3 | 14.0 | 20.2 | 17.4 | 9.8 | 7.5 | 32.5 | 13.7 | 14.2 |
| Hardness | Load: 50 μN | 14.4 | 6.8 | 11.8 | 10.2 | 7.4 | 4.4 | 17.8 | 6.2 | 7.0 |
| (N/mm²) | Load: 1000 μN | 7.5 | 3.5 | 4.9 | 4.0 | 5.0 | 2.5 | 9.5 | 3.1 | 3.8 |
| Creep | Load: 1 μN | 10.4 | 13.5 | 9.8 | 11.6 | 11.2 | 12.4 | 10.0 | 12.7 | 13.0 |
| CIT (%) | Load: 50 μN | 7.3 | 10.8 | 8.5 | 9.1 | 8.8 | 9.0 | 6.2 | 10.0 | 10.4 |
| | Load: 1000 μN | 4.5 | 7.5 | 6.3 | 5.0 | 6.4 | 6.5 | 3.0 | 6.7 | 7.2 |
| Dynamic Friction Coefficient μk | | 0.43 | 0.45 | 0.32 | 0.40 | 0.37 | 0.50 | 0.30 | 0.50 | 0.40 |
| Durability | Cleaning | GOOD | GOOD | VERY | VERY | GOOD | GOOD | GOOD | GOOD | GOOD |
| Test | Performance | | | GOOD | GOOD | | | | | |
| | Abnormal | GOOD | GOOD | GOOD | GOOD | GOOD | GOOD | GOOD | GOOD | GOOD |
| | Noise | | | | | | | | | |

| | | | | | | | | | |
|---|---|---|---|---|---|---|---|---|---|
| Contamination Test (Bleed) | GOOD | GOOD | VERY | VERY | GOOD | VERY | GOOD | GOOD | GOOD |
| | | | GOOD | GOOD | | GOOD | | | |
| Deformation Test | VERY | GOOD | GOOD | VERY | VERY | GOOD | VERY | GOOD | GOOD |
| | GOOD | | | GOOD | GOOD | | GOOD | | |

TABLE 5

| | | Comparative Example | | | | | |
|---|---|---|---|---|---|---|---|
| | | 1 | 2 | 3 | 4 | 5 | 6 |
| Average Film Thickness of | | — | 300 | 100 | 550 | 300 | 300 |
| Surface Layer (μm) | | | | | | | |
| Martens | Load: 1 μN | 4.0 | 15.1 | 52.4 | 7.6 | 13.3 | 14.8 |
| Hardness | Load: 50 μN | 1.0 | 7.3 | 41.9 | 4.7 | 6.1 | 7.2 |
| (N/mm³) | Load: 1000 μN | 0.7 | 3.9 | 35.0 | 2.7 | 3.2 | 3.9 |
| Creep | Load: 1 μN | 3.8 | 12.6 | 9.3 | 7.7 | 14.2 | 14.3 |
| CIT (%) | Load: 50 μN | 1.1 | 10.0 | 6.8 | 5.0 | 11.3 | 11.5 |
| | Load: 1000 μN | 0.7 | 6.9 | 2.8 | 3.3 | 8.0 | 8.0 |
| Dynamic Friction Coefficient μk | | 0.90 | 0.81 | 0.30 | 0.53 | 0.37 | 0.62 |
| Durability Test | Cleaning | POOR | POOR | POOR | POOR | GOOD | POOR |
| | Performance | | | | | | |
| | Abnormal Noise | POOR | POOR | POOR | GOOD | GOOD | GOOD |

| | | | | | | |
|---|---|---|---|---|---|---|
| Contamination Test (Bleed) | VERY | VERY | GOOD | VERY | POOR | VERY |
| | GOOD | GOOD | | GOOD | | GOOD |
| Deformation Test | VERY | GOOD | VERY | POOR | GOOD | GOOD |
| | GOOD | | GOOD | | | |

Comparative Example 1 refers to the base material itself used for the examples.

It has been determined that the cleaning blades according to Examples 1 to 9 are capable suppressing the movement of the contact part of the elastic member, and because the base rubber is not exposed even the blade is worn, obtaining favorable cleaning performance and suppressing the generation of abnormal noise even in long-term use. In addition, no color shift has been caused in the image forming apparatus in the tandem system.

Comparative Example 1, without any surface layer formed on the contact part, thus failed to suppress the movement of the contact part of the elastic member, and caused scooped wear, and thus generated defective cleaning and abnormal noise. In addition, Comparative Example 2 was, without any modified silicone oil contained, thus decreased in slidability, and was more likely to be worn, with defective cleaning and abnormal noise. Comparative Example 3 was, because of excessively high hardness in spite of high slidability, made brittle, and chipped or cracked, and as a result, defective cleaning was caused. Further, a high abnormal noise sounds like a squeak was generated because of the excessively high hardness. Comparative Example 4, because of the excessively large film thickness of the surface layer, lost the ability to follow the photoconductor, and caused defective cleaning, and also caused defective cleaning due to a large deformation. Comparative Example 5 generated bleed in the contamination test, because of the excessive amount of the modified silicone oil. Comparative Example 6 failed to exhibit slidability, and caused defective cleaning, because of the small amount of the modified silicone oil.

This patent application is based on and claims priority pursuant to 35 U.S.C. § 119(a) to Japanese Patent Application No. 2018-140509, filed on Jul. 26, 2018, and No. 2019-087641, filed on May 7, 2019, in the Japan Patent Office, the entire disclosure of which is hereby incorporated by reference herein.

### REFERENCE SIGNS LIST

1 Image Formation Unit
2 Frame
3 Photoconductor
4 Charging Roller
5 Developing Device
6 Cleaning Device
7 Primary Transfer Roller
10 Lubricant Applying Device
14 Intermediate Transfer Belt
40 Optical Writing Unit
41 Polygon Minor
51 Developing Roller
52 Supply Screw
53 Stirring Screw
54 Doctor
55 Registration Roller Pair
60 Transfer Unit
62 Cleaning Blade
62a Blade Tip Surface
62b Blade Lower Surface
62c Tip Ridge
621 Supporting Member
622 Base Material
623 Surface Layer
624 Elastic Member
63 First Bracket
64 Second Bracket
66 Secondary Transfer Backup Roller
67 Drive Roller
68 Auxiliary Roller
69 Tension Roller
70 Secondary Transfer Roller
80 Fixing Unit
81 Pressurizing Heating Roller
82 Fixing Belt Unit
83 Heating Roller
84 Fixing Belt
85 Tension Roller
86 Drive Roller
87 Sheet Ejection Roller Pair
88 Stack Part
100 Toner Cartridge
101 Fur Brush
103 Solid Lubricant
103a Lubricant Pressing Spring
103b Bracket
123 Image Bearer
151 First Sheet Feeding Cassette
151a First Sheet Feeding Roller
152 Second Sheet Feeding Cassette
152a Second Sheet Feeding Roller
153 Sheet Feeding Path
154 Conveyance Roller Pair
162 Belt Cleaning Unit
162a Belt Cleaning Blade
500 Image forming Apparatus (Printer)

1. A cleaning blade, comprising;
an elastic member to contact a surface of a cleaning target member and remove an adhering substance adhering to the surface of the cleaning target member,
wherein the elastic member includes a base material and a surface layer including a cured product of a curable composition,
wherein the surface layer is disposed on at least a part of a lower surface of the base material including a contact part to contact the cleaning target member, the lower surface of the base material being a surface of the base material facing a downstream side in a travelling direction of the cleaning target member with respect to the contact part,
wherein the surface layer contains a siloxane-based compound,
wherein Martens hardness of the surface layer measured with a nano indenter has a hardness gradient of decrease from a surface of the surface layer toward the lower surface of the base material in a film thickness direction of the surface layer, and the Martens hardness is 2.5 to 32.5 N/mm² in a range from a vicinity of the surface (with a load of 1 μN) to a deepest part in the film thickness direction (with a load of 1000 μN),
wherein an average film thickness of the surface layer is 10 μm or more to 500 μm or less, and
wherein a content of the siloxane-based compound in the surface layer is 4 to 15% by mass.

2. The cleaning blade according to claim 1,
wherein the surface layer includes a polyurethane-based compound and a siloxane-based compound.

3. The cleaning blade according to claim 1,
wherein the siloxane-based compound includes a modified silicone oil.

4. The cleaning blade according to claim 3,
wherein the surface layer has a sea-island structure including: a sea part including a polyurethane-based compound; and an island part including the modified silicone oil.

5. The cleaning blade according to claim 1,
wherein a creep of the surface layer, the creep measured with a nano indenter has a gradient of decrease from the surface of the surface layer toward the lower surface of the base material in the film thickness direction, and the creep is 3.0 to 13.5% in the range from the vicinity of the surface (with a load of 1 μN) to the deepest part in the film thickness direction (with a load of 1000 μN).

6. The cleaning blade according to claim 1,
wherein the surface layer is disposed in a region of at least 1 mm or more in a planar direction of the lower surface of the base material from the contact part.

7. A process cartridge, comprising:
an image bearer; and
a cleaning device to remove a toner remaining on the image bearer,
wherein the cleaning device includes the cleaning blade according to claim 1.

8. An image forming apparatus, comprising:
an image bearer;
a charger to charge a surface of the image bearer;
exposure circuitry to expose the charged image bearer to form an electrostatic latent image;
a developer to develop the electrostatic latent image with a toner to form a visible image;
a transfer device to transfer the visible image to a recording medium;
a fixer to fix the transfer image transferred to the recording medium;
and
a cleaning device to remove the toner remaining on the image bearer,
wherein the cleaning device includes the cleaning blade according to claim 1.
